(19) United States
(12) Patent Application Publication
(10) Pub. No.: US 2009/0004360 A1
(43) Pub. Date: Jan. 1, 2009

(54) Taste Potentiator Compositions in Oral Delivery Systems

(75) Inventors: Carole Ann Bingley, Reading (GB); Gino Olcese, Scarsdale, NY (US); Katherine Clare Darnell, Berkshire (GB); Thomas Niederkorn, Stamford, CT (US)

Correspondence Address: HOFFMANN & BARON, LLP, 6900 JERICHO TURNPIKE, SYOSSET, NY, 11791, US

(73) Assignee: CADBURY ADAMS USA LLC, Parsippany, NJ (US)

(21) Appl. No.: 12/120,597

(22) Filed: May 14, 2008

Related U.S. Application Data
(60) Provisional application No. 60/917,692, filed on May 14, 2007.

(51) Int. Cl. A23L 1/09; A23L 2/60

(52) U.S. Cl. 426/590; 426/660

(57) ABSTRACT

The present invention relates to edible orally delivered products, such as beverages, food products, confectioneries and chewing gum, which provide an enhanced perception of an active substance, such as a sweetener. More specifically, some embodiments provide potentiator compositions, which include at least one active substance and at least one sweetness modifier. The sweetness modifier may increase sucrose equivalence, increase the perception of sweet flavor upon consumption, decrease the perception of an aftertaste, or extend the time periods of sweetness onset, sweetness peak or sweetness decay.

### CROSS-REFERENCE TO RELATED APPLICATIONS

This application claims the benefit of U.S. Provisional Application No. 60/917,692, filed May 14, 2007, which is a continuation-in-part of U.S. patent application Ser. No. 11/439,811, filed May 23, 2006, claiming the benefit of U.S. Provisional Application No. 60/683,634, filed May 23, 2005, U.S. Provisional Application No. 60/760,437, filed Jan. 20, 2006 and U.S. Provisional Application No. 60/789,667, filed Apr. 6, 2006; and U.S. Provisional Application No. 60/917,692 is a continuation-in-part of U.S. application Ser. No. 11/439,830, filed May 23, 2006, claiming the benefit of U.S. Provisional Application No. 60/683,634, filed May 23, 2005, U.S. Provisional Application No. 60/760,437, filed Jan. 20, 2006 and U.S. Provisional Application No. 60/789,667, filed Apr. 6, 2006 and U.S. Provisional Application No. 60/917,692 is a continuation-in-part of U.S. application Ser. No. 11/439,832, filed May 23, 2006, claiming the benefit of U.S. Provisional Application No. 60/683,634, filed May 23, 2005, U.S. Provisional Application No. 60/760,437, filed Jan. 20, 2006 and U.S. Provisional Application No. 60/789,667, filed Apr. 6, 2006, the contents all of which are incorporated herein by reference.

### FIELD

The present invention includes oral compositions that provide an enhanced perception of an active substance contained therein. In particular, the compositions may include an active substance, such as a sweetener or flavor, and a sweetness modifier. The sweetness modifier may increase the perception of sweetness upon consumption. The compositions may be incorporated into various types of edible orally delivered products, such as beverages, food products, confectionery or chewing gum products.

### BACKGROUND

There are five primary categories of taste that are sensed by humans: sour, salty, sweet, bitter and umami (savory or the taste of glutamate). The taste of a substance is sensed by taste receptor cells located in taste buds primarily on the surface of the tongue and palate in the oral cavity. Each of the primary taste qualities is sensed by a specific mechanism. It is believed that sour and salty tastes are detected by the passage of ions, hydrogen and sodium respectively, through the ion channels in taste bud cells. This triggers a nerve impulse that is sensed in the brain as sour or salty. In contrast, it is believed that sweet, bitter and umami tastes are perceived by physical binding to receptors. In general, sweet, bitter and umami sensing taste cells have G-protein coupled receptors (GPCRs) on their surface. These receptors are activated when they bind to tastants, which initiates a series of signaling events that trigger a nerve impulse that is sensed in the brain as sweet, bitter or savory.

Over the past several years, there have been a number of advances in research on taste perception. New taste receptor proteins have been identified in mammals, particularly two families of G-protein coupled receptors (T2Rs and T1Rs), which are believed to be involved in taste perception. Such receptors are discussed in more detail in International Publication Nos. WO 02/064631 and WO 03/001876. These publications disclose that co-expression of certain T1R receptors results in savory or sweet taste receptors that respond to savory or sweet taste stimuli, respectively.

Recent advances in the understanding of taste perception have created interest in identifying new compounds for stimulating these taste receptors. In particular, research efforts also have been directed to methods of identifying compounds that may enhance the primary taste perceptions, such as sweet or savory perceptions. The development of substances that provide flavor enhancement is of particular interest, and such substances are generally referred to as taste or flavor enhancers, or potentiators. These substances have been thought to contribute taste, aroma and feeling factors, as well as potentiate and suppress other flavors. The activity of taste or flavor enhancers is often referred to as synergistic because they enhance or increase the perception of another substance.

One category of taste potentiators of particular interest includes compounds that enhance sweetness. Although naturally-occurring carbohydrate sweeteners, such as sucrose, are the most widely used sweeteners, they suffer from the disadvantages of high cost and high caloric content. Artificial sweeteners have been designed that overcome these problems but they are sometimes rejected by the consumer for not having a sufficiently “sucrose-like” taste. Artificial sweeteners have different sweetness profiles from that of sucrose and often suffer from side effects such as delays in the onset of sweetness perception and/or unpleasant aftertastes.

Compounds are known which, when combined with a sweetener, modify the taste of the sweetener. Such compounds are usually referred to as sweetness modifiers or potentiators. They may act to enhance or inhibit the perception of the sweetness of the sweetener or may affect the sweetness profile in some way. For example, Canadian Patent No. 1208966 discloses a broad range of aromatic compounds that are claimed as sweetness modifiers.

European Patent No. 0132444 and U.S. Pat. No. 4,627,987 describe 3-hydroxybenzoic acid (3-HB) as a sweetness potentiator and exemplify its use with sucrose, aspartame and saccharin to enhance sweetness when employed at pH 2.0 to 5.5.

2,4-Dihydroxybenzoic acid (2,4-DHB) also is described as a sweetness potentiator, but the literature is ambiguous as to its effects. In U.S. Pat. No. 5,232,735 it is listed as a “substantially tasteless sweetness inhbitor” whereas in Canadian Patent No. 1208966 the addition of 0.2% 2,4-DHB to a 5% sucrose solution is said to have resulted in an increase in sweetness. International Publication No. WO99/15032 describes the use of 2,4-DHB with aspartame to increase sweetness synergistically and provide a more “sucrose-like” taste and mouthfeel. The combination is considered peculiar, in that the same effect is not observed when 2,4-DHB is combined with the alternative artificial sweeteners, alitame, Ace-K (acesulfame potassium), saccharin or even a mixture of aspartame and Ace-K. U.S. Pat. No. 6,461,658 claims that 2,4-DHB improves the sweetness delivery profile of the artificial sweetener sucralose by significantly reducing the length of time during which sucralose sweetness is perceived. The same effect is not observed for aspartame even though this might be expected in light of International Publication No. WO099/15032. FIGS. 1 and 2 and Tables 1 and 2 of U.S. Pat. No. 6,461,658 seem to indicate that 2,4-DHB has a slightly inhibitory effect on the sweetness intensity of both sucralose and aspartame although this is not discussed in the text.

International Publication No. WO00/69282 describes the modification of the taste and physicochemical properties of the sweetener neotame by the addition of at least one taste modifying hydrophobic acid additive. The taste modifying hydrophobic acid additive is limited only in that it must positively affect at least one taste characteristic imparted by neotame. These characteristics appear to be related to the sweetness profile, specifically the onset and linger period, but the examples do not describe how the characteristics have been affected. 3-HB and 2,4-DHB are listed among a very large number of such additives.

Additionally, there have been a number of recent developments related to methods of identifying substances that function as taste potentiators. Various assays have been developed to identify target compounds that modulate the activity of taste receptors, and thus, may become successful taste potentiators. For example, International Publication Nos. WO 02/064631 and WO 03/0010876, referred to above, disclose assays and high-throughput screens that measure certain T1R receptor activity in the presence of target compounds.

U.S. Pat. No. 6,955,887 to Adler et al., discloses methods for identifying taste potentiators using newly identified mammalian taste-cell-specific G-protein coupled receptors. More specifically, U.S. Pat. No. 6,955,887 teaches methods for screening target compounds that may be used to modulate the sweet taste perception.

Various other methods for screening compounds that may be used as taste potentiators are disclosed in the U.S. Patent Publication Nos. 2005/0287517A1, 2005/0084932A1, 2005/00699444A1, 2005/10032158A1, 2004/0229239A1, 2004/0209286A1, 2004/0191805A1, 2004/0185469A1, 2004/0175793A1, 2004/0175792A1, 2004/171042A1, 2004/0132075A1, 2004/0072254A1, 2003/0232407A1, 2003/0170608A1 and 2003/0054448A1.

Despite progress in developing methods for identifying new taste potentiators, there is still a need for oral, particularly beverage and confectionery, compositions that include sweetness modifiers. It would be desirable to develop a sweetness modifier composition that allows the quantity of natural or artificial sweetener in an orally delivered product to be reduced, thereby reducing the cost of production and the calorie content of the orally delivered product, but which avoids adverse effects on flavor. In particular, there is a need for a new sweetness modifier which is capable of increasing the sucrose equivalence of a sweetener. Moreover, there is a need for a sweetener composition that is capable of increasing the sucrose equivalence, as well as, modifying the perception of sweet flavor of the sweetener, the aftertaste of the sweetener, the sweetness onset period of the sweetener, the sweetness peak period of the sweetener and/or the sweetness decay period of the sweetener.

### SUMMARY

In some embodiments, there is a provided a sweetener composition including: at least one sweetener having a sucrose equivalence; a first non-sweetener composition including a sucrose equivalence modifier which increases the sucrose equivalence of the at least one sweetener; and a second composition including a sweet flavor modifier which modifies a perception of sweet flavor.

In other embodiments, there is provided a sweetener composition including: at least one sweetener having a sucrose equivalence and a temporal sweetness profile including a sweetness onset period; a first non-sweetener composition including a sucrose equivalence modifier which increases the sucrose equivalence of the at least one sweetener; and a second composition including a sweetness onset period modifier which modifies the sweetness onset period of the at least one sweetener.

In some embodiments, there is provided a sweetener composition including: at least one sweetener having a sucrose equivalence and a temporal sweetness profile including a sweetness peak period; a first non-sweetener composition including a sucrose equivalence modifier which increases the sucrose equivalence of the at least one sweetener; and a second composition including a sweetness peak period modifier which modifies the sweetness peak period of the at least one sweetener.

In some embodiments, there is provided a sweetener composition including: at least one sweetener having a sucrose equivalence and a temporal sweetness profile including a sweetness decay period; a first non-sweetener composition including a sucrose equivalence modifier which increases the sucrose equivalence of the at least one sweetener; and a second composition including a sweetness decay period modifier which modifies the sweetness decay period of the at least one sweetener.

In other embodiments, a sweetener composition including: at least one sweetener having a sucrose equivalence and a temporal sweetness profile including an aftertaste; a first non-sweetener composition including a sucrose equivalence modifier which increases the sucrose equivalence of the at least one sweetener; and a second composition including an aftertaste modifier which modifies the aftertaste of the at least one sweetener.

In some embodiments, a sweetener composition including: at least one sweetener selected from sucrose, high fructose corn syrup, corn syrup, sucromalt, isomaltulose, and combinations thereof having a sucrose equivalence; a first composition including a sucrose equivalence modifier which increases the sucrose equivalence of the at least one sweetener selected from monohydroxybenzoic acids, dihydroxybenzoic acids, aminobenzoic acids, methoxysalicyclic acids, and combinations thereof.

In some embodiments, a beverage composition including: at least one sweetener having a sucrose equivalence; a first non-sweetener composition including a sucrose equivalence modifier which increases the sucrose equivalence of the at least one sweetener and wherein the sweetener composition has a sweet flavor; and a second composition including a sweet flavor modifier which modifies the sweet flavor of the sweetener composition; ad at least one flavoring agent.

In some embodiments, a beverage composition including: at least one sweetener characterized by a sucrose equivalence and a temporal sweetness profile including a sweetness onset period; a first composition including a sucrose equivalence modifier which increases the sucrose equivalence of the at least one sweetener; a second composition including a sweetness onset period modifier which modifies the sweetness onset period of the at least one sweetener; and at least one flavoring agent.

In some embodiments, a beverage composition including: at least one sweetener characterized by a sucrose equivalence and a temporal sweetness profile including a sweetness peak period; a first non-sweetener composition including a sucrose equivalence modifier which increases the sucrose equivalence of the at least one sweetener, a second composition which modifies the sweetness peak period of the at least one sweetener; and at least one flavoring agent.

In some embodiments, a beverage composition including: at least one sweetener characterized by a sucrose equivalence and a temporal sweetness profile including a sweetness decay period; a first non-sweetener composition including a sucrose equivalence modifier which increases the sucrose equivalence of the at least one sweetener; a second composition including a sweetness decay period modifier which modifies the sweetness decay period of the at least one sweetener; and at least one flavoring agent.

In other embodiments, a beverage composition including: at least one sweetener characterized by a sucrose equivalence and a temporal sweetness profile including an aftertaste; a first non-sweetener composition including a sucrose equivalence modifier capable of increasing the sucrose equivalence of the at least one sweetener; and a second composition including an aftertaste modifier capable of modifying the aftertaste of the at least one sweetener.

In some embodiments, beverage composition including: a first amount of 3-hydroxybenzoic acid; a second amount of 3,4-dihydroxybenzoic acid, a third amount of a taste modifying compound selected from maltol, thaumatin, and combinations thereof; and a fourth amount of at least one sweetener selected from sucrose, high fructose corn syrup, corn syrup, sucromalt, isomaltulose, lactose, galactose, xylose, oligosaccharides, fructooligosaccharides, polydextrose, honey, brown rice syrup, agave syrup, molasses, brown sugar, and combinations thereof.

In some embodiments, a method of making a sweetener composition including the steps of: providing at least one sweetener having a sucrose equivalence; and providing a first composition including a sucrose equivalence modifier which increases the sucrose equivalence of the at least one sweetener, wherein the increased sucrose equivalence is greater than the sucrose equivalence of the at least one sweetener.

In some embodiments, a method of making a beverage including the steps of: providing at least one sweetener having a sucrose equivalence; providing a first composition including a sucrose equivalence modifier which increases the sucrose equivalence of the at least one sweetener, wherein the increased sucrose equivalence is greater than the sucrose equivalence of the at least one sweetener; and providing at least one flavor.

In some embodiments, a method of reducing an amount of at least one sweetener in a comestible providing the steps of: determining a first amount of a first composition including at least one sweetener having a sucrose equivalence; reducing the first amount by at least 30% w/w; and determining a second amount of a second composition including a sucrose equivalence modifier which increases the sucrose equivalence of the at least one sweetener wherein the second amount provides the sucrose equivalence.

### DETAILED DESCRIPTION

Embodiments provided herein provide oral delivery systems such as beverages, confectionery products, chewing gum products, and food products, containing sweetness modifiers that provide the advantage of increasing the sucrose equivalence of a sweetener. Additionally, these sweetener compositions may provide the advantage of modifying the quality and/or temporal profile of the sweetness perception. More specifically, these compositions may include components that are capable of modifying the sweet flavor, the sweetness onset, the sweetness peak period, the sweetness decay period, and/or the aftertaste of the sweetener.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

As used herein, the term “foodstuff” means any edible oral composition including beverages, confectionery products, chewing gum products, or food products.

The term “beverage” as used herein means any drinkable liquid or semi-liquid, including for example flavored water, soft drinks, fruit drinks, coffee-based drinks, tea-based drinks, juice-based drinks, milk-based drinks, jelly drinks, carbonated or non-carbonated drinks, alcoholic or non-alcoholic drinks.

The term “beverage concentrate” or “beverage base” as used herein means an intermediate beverage product which, when mixed with an appropriate amount of water or other suitable liquid or semi-liquid and/or a sweetening agent, forms a beverage syrup or alternatively a beverage. The beverage concentrate generally comprises a flavoring agent and optional additives.

The term “beverage syrup” as used herein means an intermediate beverage product prepared from a beverage concentrate, a sweetening agent, and an amount of water or other suitable liquid or semi-liquid. The beverage syrup is in a concentrated form that can be diluted to form a beverage. The beverage syrup generally comprises a flavoring agent, a sweetening agent, and optional additives such as food-grade acids, coloring agents, and the like.

As used herein, the terms “bubble gum” and “chewing gum” are used interchangeably and are both meant to include any gum compositions.

As used herein, the term “confectionery base” includes any ingredient or group of ingredients that represent form the bulk of the confectionery composition and provide the confectionery composition with its structural integrity and to which other ingredients are added.

As used herein, the term “food product” means any foodstuff which is not a beverage, confectionery or chewing gum as defined above, including for example, yogurts, sauces such as apple sauce, cookies, breads, cakes, condiments such as tabletop sweeteners, mustard, relish and ketchup, puddings, dry or powder mixes such as pudding mix, hot chocolate mix, fruit juice mix, drink mix lemonade mix, and the like.

The term “flavor key” as used herein is a flavor component containing flavoring; agents such as flavored oils, and the like, and is typically used to prepare a flavor essence.

The term “flavor essence” (“flavor blend”, “flavor extract”) as used herein is a flavor component generally prepared from a flavor key.

Embodiments described herein provide compositions for oral delivery of an active substance. Numerous different active substances may be employed, such as, for example, flavors. The compositions also may include a taste potentiator. The taste potentiator may act in a synergistic manner when used in conjunction with the active substance to enhance the perception of the active substance during consumption. Additionally, in some embodiments, the taste potentiator may be encapsulated to provide a controlled release profile, i.e., delayed or increased rate of release upon consumption. The taste potentiator accordingly may release over an extended period of time throughout the consumption of the product into which the composition is incorporated, such as, for example, chewing gum.

### Potentiator Compositions

Embodiments described herein provide compositions that may include at least one active substance, such as sweeteners and at least one taste potentiator composition, such as a sweetness modifier. The potentiator compositions may have controlled-release properties. The taste potentiator(s) may work synergistically with the active substance(s) to enhance the perception of the active(s). For instance, in some embodiments, the active substance may be a sweetener. Delivery of the sweetener in combination with at least one sweetness modifier may enhance the sweetness perception upon consumption of the composition. In particular, the sweetness modifier(s) may function synergistically with the sweetener to enhance the sweetness perception. The incorporation of the potentiator(s), therefore, allows for reduced amounts of sweetener without compromising the level of sweetness provided by the composition. Due to the calories contained in many conventional sweeteners, such as sugar, these results may be highly desirable. Additionally, there may be significant cost savings associated with the reduction in sweetener amounts used in the composition.

For purposes of some embodiments described herein, “taste potentiator” refers to substances that may enhance the perception of an active substance during consumption of the composition. For purposes of some embodiments described herein, the term “enhance” means to intensify, supplement, modify, modulate or potentiate. Some taste potentiators may be referred to more specifically by reference to the type of active they enhance. For example, sweetener potentiators (or sweetness modifiers) enhance the perception of a sweetener during consumption and flavor potentiators enhance the perception of a flavor during consumption. These more specific examples, however, are merely subsets of taste potentiators and are encompassed by the general term “taste potentiator” as used herein.

Taste potentiators may have a synergistic effect when used in conjunction with an active, i.e., by enhancing the taste effects of the active substance such that the total effect is greater than the sum of the taste effects of the individual substances alone. In addition, some taste potentiators do not introduce a characteristic taste and/or aroma perception of their own.

In some embodiments, for instance, the taste potentiator(s) may enhance the sour, sweet, bitter, salty or umami taste of a composition. The taste potentiator(s) also may function to enhance the effects of a variety of other active substances, as discussed in more detail below.

Any of a variety of substances that function as taste potentiators may be employed in the compositions described herein. For instance, suitable taste potentiators include water-soluble taste potentiators, such as, but not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumalin, tagatose, trehalose, salts, such as sodium chloride, monoammonium glycyrrhizinate, vanilla extract (in ethyl alcohol), water-soluble sugar acids, potassium chloride, sodium acid sulfate, water-soluble hydrolyzed vegetable proteins, water-soluble hydrolyzed animal proteins, water-soluble yeast extracts, adenosine monophosphate (AMP), glutathione, water-soluble nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, monohydroxy benzoic acids, such as 2-hydroxybenzoic acid (2-HB), 3-hydroxybenzoic acid (3-HB) and 4-hydroxybenzoic acid (4-HB), dihydroxy benzoic acids, such as 2,3-dihydroxybenzoic acid (2,3-DHB), 2,4-dihydroxybenzoic acid (2,4-DHB), 2,5-dihydroxybenzoic acid (2,5-DUB), 2,6-dihydroxybenzoic acid (2,6-DHB), 3,4-dihydroxybenzoic acid (3,4-DUB) and 375-dihydroxybenzoic acid (3,5-DHB), trihydroxy benzoic acids, such as 2,3,4-trihydroxybenzoic acid (2,3,4-THB), 2,4,6-trihydroxybenzoic acid (2,4,6-THB) and 3,4,5-trihydroxybenzoic acid (3,4,5-THB), 4-hydroxyphenylacetic acid, 2-hydroxyisocaproic acid, 3-hydroxycinnamic acid, aminobenzoic acids, such as 3-aminobenzoic acid and 4-aminobenzoic acid, hydroxyl deoxybenzoins, methoxy salicylic acids and combinations thereof.

Other suitable taste potentiators are substantially or completely insoluble in water, such as, but not limited to, citrus aurantium, vanilla oleoresin, water insoluble sugar acids, water insoluble hydrolyzed vegetable proteins, water insoluble hydrolyzed animal proteins, water insoluble yeast extracts, insoluble nucleotides, sugarcane leaf essence and combinations thereof.

Some other suitable taste potentiators include substances that are slightly soluble in water, such as, but not limited to, maltol, ethyl maltol, vanillin, slightly water-soluble sugar acids, slightly water-soluble hydrolyzed vegetable proteins, slightly water-soluble hydrolyzed animal proteins, slightly water-soluble yeast extracts, slightly water-soluble nucleotides and combinations thereof.

Additional suitable taste potentiators include, but are not limited to, licorice glycyrrhizinates, compounds that respond to G-protein coupled receptors (T2Rs and T1Rs), G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”. Kokumi imparting compositions may be water-soluble, slightly water-soluble or insoluble in water.

As mentioned above, sweetness modifiers, which are a type of taste potentiator, enhance the perception of sweetness. The perception of sweetness involves multiple variables two of which include taste and flavor. Taste and flavor are perceived by different mechanisms for interpreting sweetness. More specifically, taste is perceived through action on the taste receptors in the oral cavity. These receptors determine the basic sweetness, sourness, bitterness and/or saltiness of a composition upon consumption. The flavor variable is perceived through an olfactory mechanism. Flavor is characterized by the fullness and roundness of the aroma of the composition upon consumption.

Some embodiments described herein include a sweetener and one or more sweetness modifiers to affect the sweet flavor and/or taste of the composition. For instance, in some embodiments, it may be desirable to use less sweetener in a composition. However, decreasing the amount of sweetener in a composition may have a negative impact on the perceived sweetness, i.e. taste and flavor, of the composition. As such, additional components may be added to the composition to balance out the sweetener profile and modify the perceived quality and/or duration of sweetness.

In some embodiments, a sweetness quality variable may be used to modify the quality of perceived sweetness. Sweetness quality variables may be selected for use with a sweetener to alter the intensity of the sweetener, the fullness of the sweetener or decrease the perceived bitterness of a sweetener. More specifically, useful sweetness quality variables include “sweetness equivalence modifiers”, “sweet flavor modifiers” and “aftertaste modifiers.”

The perception of sweetness is often referred to in terms of sucrose equivalence. Sucrose equivalence is a standard used to measure sweetness as compared to the baseline of sucrose. All sweeteners, including sugarless and high intensity sweeteners, are measured against the standard sweetener, sucrose. Accordingly, the sweetener profile and perceived level of sweetness should, ideally, be comparable to that of sucrose. One method of measuring the perceived sweetness of a solution is by calculating its sucrose equivalent value (hereinafter “SEV”). Sucrose equivalence may be defined as the amount of sweetener required to impart the comparable level of sweetness perceived from a given amount of sucrose. The SEV are determined by comparing the solution with a stock sucrose solution of known concentration. Concentrations of sweeteners with sweetness intensities equivalent to a sucrose standard can also be described as being “isosweet” to sucrose. For example, aspartame is recognized as being 200 times sweeter than sucrose. Thus, 100 milliliters of a solution with 0.05 grams of aspartame is expected to be isosweet to 100 milliliters of a solution with 10 grams of sucrose.

In some embodiments, the use of sucrose equivalence modifiers permits the use of less sweetener without the loss of the total sweetness perception. As used herein, the term “sucrose equivalence modifier” includes any component that increases the perception of sweetness intensity of the sweetener composition. “Sucrose equivalence modifiers” are a taste component of perceived sweetness. Thus, “sucrose equivalence modifiers” may be used to increase the level of sweetness perceived in comparison to a certain amount of sucrose.

As used herein, the term “sweet flavor modifier” includes any component that increases the sweet flavor, such as the fullness or roundness, of a sweetener composition. “Sweet flavor modifiers” act on the olfactory receptors, and thus, are a flavor component.

Aftertaste means the perception of bitterness or undesirable flavor which lingers in the mouth. As used herein, the term “aftertaste modifier” may include any composition which decreases the perception of bitterness or undesirable flavor when added to a sweetener composition. Thus, “aftertaste modifiers” are taste components.

In some embodiments, a temporal profile variable may be used to modify the duration of perceived sweetness. Temporal profile variables involve both taste and flavor components. Temporal profile variables may alter the onset period of the perceived sweetness, peak period of the perceived sweetness and/or decay period of the perceived sweetness. By altering such time periods, the sweetness profile can be modified to smooth out any peaks in the profile and create a more gradual sweetness perception over time.

As used herein, the term “sweetness onset period modifier” includes any component that extends or delays the initiation of the onset time of sweetness perception. “Sweetness onset period modifiers” also includes any component that shortens or hastens the termination of the onset time of sweetness perception or any component that maintains or leaves unchanged the onset time of sweetness, “Sweetness onset period modifiers” are both taste and flavor components of sweetness.

As used herein, the term “sweetness peak period modifier” includes any component that extends the length or duration of the peak of sweetness perception. “Sweetness peak period modifiers” also includes any component that shortens or hastens the termination of the peak time of sweetness perception or any component that maintains or leaves unchanged the peak time of sweetness. “Sweetness peak period modifiers” have taste and flavor components of sweetness.

As used herein, the term “sweetness decay period modifier” includes any component that extends the time period prior to the decline of sweetness perception. “Sweetness decay period modifiers” also includes any component that shortens or hastens the termination of the decay time of sweetness perception or any component that maintains or leaves unchanged the decay time of sweetness. “Sweetness decay period modifiers” have taste and flavor components of sweetness.

In some embodiments, a sweetener composition may include a sweetener and a sucrose equivalence modifier. In some embodiments, any one or more of the sweetness quality variables or temporal profile variables may be combined with the sweetener and sucrose equivalence modifier to achieve the desired perception of sweetness over time.

Exemplary sweetness modifiers include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), 2-hydroxybenzoic acid (2-HB), 3-hydroxybenzoic acid (3-HB), 4-hydroxybenzoic acid (4-HB), 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, 3-aminobenzoic acid, 4-aminobenzoic acid and combinations thereof.

A non-limiting list of components which may be used to alter the sweetness quality of a sweetener composition by increasing the sucrose equivalence, increasing the sweet flavor and/or decreasing the aftertaste are shown below in Table 1. In some embodiments, it may be desirable to include a sweetener and sucrose equivalence modifier together in the sweetener composition. Sweet flavor modifiers and/or aftertaste modifiers may be added to further modify the perceived sweetness of the composition. Optionally, as shown below in Table 2, any one or more of the temporal profile modifiers may also be added to further adjust the sweetness profile.

TABLE 1
Sweetness Quality Variables for Sweetness Modifiers

| | Sweetness Quality Variables | | |
|---|---|---|---|
| | Sucrose Equivalence | | |
| | Modifier | Sweet Flavor Modifier | Aftertaste Modifier |
| Sweetener | Increase | Increase | Decrease |
| Sugar, sugarless, high | Monohydroxy benzoic | Vanilla, vanillin, vanillic | Yerba santa, |
| intensity | acids, dihydroxy | acid, vanillin acetate, vanillin | monocarboxylic acids, |
| | benzoic acids, | PG acetal caffeic acid, maltol, | dicarboxylic acids, |
| | trihydroxy benzoic | ethyl maltol, thaumatin, | calcium lactate, |
| | acids, aminobenzoic | furaneol, cyclotene, menthyl | magnesium lactate, |
| | acids, hydroxyl | acetate, glycyrrhizin, | sodium lactate, |
| | deoxybenzoins, | perillartine, nucleotides, | calcium gluconate, |
| | methoxy salicylic | AMP, IMP, GMP, tagatose, | sodium gluconate, |
| | acids | erythritol, L-aspartic acid, | monosodium |
| | | piperine, gingerin, l(p- | gluconate, magnesium |
| | | methoxy phenyl) l-penten-3- | gluconate, β-alanine, |
| | | one, heliotropine, o-methoxy | trans-4-hydroxy-L- |
| | | cinnamicaldehyde, b-ionol, 4- | proline, trans-4- |
| | | p-acetoxylphenyl-2-butanone, | hydroxy-D-proline, L- |
| | | 2 acetyl pyrrole, Fir Balsam | arginine, L- |
| | | Absolute, Vanillin alcohol, | tryptophan, balsam |
| | | Piperonyl isobutryate, | peru, quinine, |
| | | Vanillylidin acetone, vanillin | naringin, naringenin, |
| | | isobutyrate, delta and gamma | sugar alcohols, |
| | | lactones (C4-C14), 2,4 | polyols, erythritol, |
| | | dimethyl benzaldehyde, | maltitol, sorbitol, |
| | | menthalactone, 2-propionyl | isomalt, tagatose, |
| | | pyrrole, 4-oxoisophorone, | trehalose, fructo oligo |
| | | theaspirane 3-ethyl-2- | saccharides, alkali |
| | | hydroxy-2-cyclopenten-1- | metal cations, alkaline |
| | | one, furfural, veratraldehyde, | earth metal cations, |
| | | zingerone, vanitrope, anisic | benzyl amides, |
| | | aldehyde, anisyl alcohol, | hydroxylated benzoic |
| | | sulfurol, oak moss, benzoin, | acid amides, |
| | | benzaldehyde, umbretalide, | homoeriodictyol, |
| | | ethyl vanillin, phenyl acetate, | sodium salt of |
| | | cinnamyl acetate benzyl | homoeriodictyol, |
| | | cinnamate, anethol, | serubin, eriodictyol, |
| | | isophoeone phenyl ethyl | eriodictyol-7- |
| | | buryate, phenyl ethyl | methylether, cream of |
| | | proprionate, phenyl ethyl | tartar, galactose, |
| | | cinnamate 2,5 xylenol + | phospholipids, |
| | | isomers, molasses distillates, | monellin, tannic acid, |
| | | honey distillates, sugar | phenolic acid, |
| | | distillates, bitter suppressing | |
| | | agents, essential oils, citrus | |
| | | oils, expressed oils, distilled | |
| | | oils, rose oil, limonene, | |
| | | menthol, methyl butanoate, | |
| | | pentyl butanoate, extracts, | |
| | | pyridinium betaines, flavones, | |
| | | 2-phenylchrom-2-en-4-one, | |
| | | 5-hydroxyflavone, cumarine, | |
| | | delta lactones, methyl | |
| | | sorbate, divanillin, fruit | |
| | | esters, phenyl acetaldehyde | |
| Sucrose, HFCS, corn | 2HB; 2,4DHB, 3HB; | Vanilla, vanillin, vanillic | Yerba santa, |
| syrup, sucromalt, | 3,4DHB; 4MS; 3AB; | acid, vanillin acetate, vanillin | monocarboxylic acids, |
| isomaltulose, lactose, | p-anisic acid | PG acetal caffeic acid, maltol, | dicarboxylic acids, |
| galactose, xylose, | | ethyl maltol, thaumatin, | calcium lactate, |
| oligosaccharides, | | furaneol, cyclotene, menthyl | magnesium lactate, |
| fructo- | | acetate, glycyrrhizin, | sodium lactate, |
| oligosaccharides, | | perillartine, nucleotides, | calcium gluconate, |
| polydextrose, honey, | | AMP, IMP, GMP, tagatose, | sodium gluconate, |
| brown rice syrup, | | erythritol, L-aspartic acid, | monosodium |
| agave syrup, | | piperine, gingerin, l(p- | gluconate, magnesium |
| molasses, brown | | methoxy phenyl) l-penten-3- | gluconate, β-alanine, |
| sugar, tagatose, | | one, heliotropine, o-methoxy | trans-4-hydroxy-L- |
| trehalose | | cinnamicaldehyde, b-ionol, 4- | proline, trans-4- |
| | | p-acetoxylphenyl-2-butanone, | hydroxy-D-proline, L- |
| | | 2 acetyl pyrrole, Fir Balsam | arginine, L- |
| | | Absolute, Vanillin alcohol, | tryptophan, balsam |
| | | Piperonyl isobutryate, | peru, quinine, |
| | | Vanillylidin acetone, vanillin | naringin, naringenin, |
| | | isobutyrate, delta and gamma | sugar alcohols, |
| | | lactones (C4-C14), 2,4 | polyols, erythritol, |
| | | dimethyl benzaldehyde, | maltitol, sorbitol, |
| | | menthalactone, 2-propionyl | isomalt, tagatose, |
| | | pyrrole, 4-oxoisophorone, | trehalose, fructo oligo |
| | | theaspirane 3-ethyl-2- | saccharides, alkali |
| | | hydroxy-2-cyclopenten-1- | metal cations, alkaline |
| | | one, furfural, veratraldehyde, | earth metal cations, |
| | | zingerone, vanitrope, anisic | benzyl amides, |
| | | aldehyde, anisyl alcohol, | hydroxylated benzoic |
| | | sulfurol, oak moss, benzoin, | acid amides, |
| | | benzaldehyde, umbretalide, | homoeriodictyol, |
| | | ethyl vanillin, phenyl acetate, | sodium salt of |
| | | cinnamyl acetate benzyl | homoeriodictyol, |
| | | cinnamate, anethol, | serubin, eriodictyol, |
| | | isophoeone phenyl ethyl | eriodictyol-7- |
| | | buryate, phenyl ethyl | methylether, cream of |
| | | proprionate, phenyl ethyl | tartar, galactose, |
| | | cinnamate 2,5 xylenol + | phospholipids, |
| | | isomers, molasses distillates, | monellin, tannic acid, |
| | | honey distillates, sugar | phenolic acid, |
| | | distillates, bitter suppressing | |
| | | agents, essential oils, citrus | |
| | | oils, expressed oils, distilled | |
| | | oils, rose oil, limonene, | |
| | | menthol, methyl butanoate, | |
| | | pentyl butanoate, extracts, | |
| | | pyridinium betaines, flavones, | |
| | | 2-phenylchrom-2-en-4-one, | |
| | | 5-hydroxyflavone, cumarine, | |
| | | delta lactones, methyl | |
| | | sorbate, divanillin, fruit | |
| | | esters, phenyl acetaldehyde | |
| Sorbitol, mannitol, | 2HB; 2,4DHB, 3HB; | | |
| maltitol, isomalt, | 3,4DHB; 4MS; 3AB; | | |
| erythritol, xylitol, | p-anisic acid | | |
| glycerol | | | |
| APM, Ace-K, | 2HB; 2,4DHB, 3HB; | Vanilla, vanillin, vanillic | Yerba santa, |
| sucralose, saccharin, | 3,4DHB; 4MS; 3AB; | acid, vanillin acetate, vanillin | monocarboxylic acids, |
| cyclamate, neotame, | p-anisic acid | PG acetal caffeic acid, maltol, | dicarboxylic acids, |
| alitame, NHDC, | | ethyl maltol, thaumatin, | calcium lactate, |
| monatin, lo han quo, | | furaneol, cyclotene, menthyl | magnesium lactate, |
| extract of the fruit of | | acetate, glycyrrhizin, | sodium lactate, |
| the Cucurbitaceae | | perillartine, nucleotides, | calcium gluconate, |
| family, stevioside | | AMP, IMP, GMP, tagatose, | sodium gluconate, |
| | | erythritol, L-aspartic acid, | monosodium |
| | | piperine, gingerin, l(p- | gluconate, magnesium |
| | | methoxy phenyl) l-penten-3- | gluconate, β-alanine, |
| | | one, heliotropine, o-methoxy | trans-4-hydroxy-L- |
| | | cinnamicaldehyde, b-ionol, 4- | proline, trans-4- |
| | | p-acetoxylphenyl-2-butanone, | hydroxy-D-proline, L- |
| | | 2 acetyl pyrrole, Fir Balsam | arginine, L- |
| | | Absolute, Vanillin alcohol, | tryptophan, balsam |
| | | Piperonyl isobutryate, | peru, quinine, |
| | | Vanillylidin acetone, vanillin | naringin, naringenin, |
| | | isobutyrate, delta and gamma | sugar alcohols, |
| | | lactones (C4-C14), 2,4 | polyols, erythritol, |
| | | dimethyl benzaldehyde, | maltitol, sorbitol, |
| | | menthalactone, 2-propionyl | isomalt, tagatose, |
| | | pyrrole, 4-oxoisophorone, | trehalose, fructo oligo |
| | | theaspirane 3-ethyl-2- | saccharides, alkali |
| | | hydroxy-2-cyclopenten-1- | metal cations, alkaline |
| | | one, furfural, veratraldehyde, | earth metal cations, |
| | | zingerone, vanitrope, anisic | benzyl amides, |
| | | aldehyde, anisyl alcohol, | hydroxylated benzoic |
| | | sulfurol, oak moss, benzoin, | acid amides, |
| | | benzaldehyde, umbretalide, | homoeriodictyol, |
| | | ethyl vanillin, phenyl acetate, | sodium salt of |
| | | cinnamyl acetate benzyl | homoeriodictyol, |
| | | cinnamate, anethol, | serubin, eriodictyol, |
| | | isophoeone phenyl ethyl | eriodictyol-7- |
| | | buryate, phenyl ethyl | methylether, cream of |
| | | proprionate, phenyl ethyl | tartar, galactose, |
| | | cinnamate 2,5 xylenol + | phospholipids, |
| | | isomers, molasses distillates, | monellin, tannic acid, |
| | | honey distillates, sugar | phenolic acid, |
| | | distillates, bitter suppressing | |
| | | agents, essential oils, citrus | |
| | | oils, expressed oils, distilled | |
| | | oils, rose oil, limonene, | |
| | | menthol, methyl butanoate, | |
| | | pentyl butanoate, extracts, | |
| | | pyridinium betaines, flavones, | |
| | | 2-phenylchrom-2-en-4-one, | |
| | | 5-hydroxyflavone, cumarine, | |
| | | delta lactones, methyl | |
| | | sorbate, divanillin, fruit | |
| | | esters, phenyl acetaldehyde | |

A non-limiting list of components that may be used to alter the temporal profile by extending the sweetness onset period, the sweetness peak period or the sweetness decay period are shown below in Table 2. In addition to temporal profile modifiers that extend the sweetness onset period, the sweetness peak period, or the sweetness decay period, modifiers that shorten or maintain each of the temporal periods are also contemplated as are all combinations. For example, a temporal profile modifier that extends the sweetness onset period may be combined with a temporal profile modifier that shortens the sweetness decay period or a temporal profile modifier that shortens the sweetness onset period could be combined with a temporal profile modifier that maintains the sweetness peak period and so on.

TABLE 2
Temporal Profile Variables for Sweetness Modifiers

| | Temporal Profile Variables | | |
|---|---|---|---|
| | Sweetness Onset | Sweetness Peak | Sweetness Decay Period |
| | Period Modifier | Period Modifier | Modifier |
| Sweetener | Extend | Extend | Extend |
| Sugar, sugarless, high | Sodium chloride, | Octahydro coumarin, | l-lysine, magnesium |
| intensity | sodium gluconate, | methylcyclo | gluconate, magnesium |
| | sodium citrate, tannic | pentenlone, | chloride, magnesium |
| | acid, 2-ethyl-4-(H)-5- | dihydrocumarin | sulphate, thaumatin, |
| | methyl-3(2H)- | methyl coumarin, | neohesperidine, |
| | furanone, 4,5- | anise oil | dihydrochalcone, mono- |
| | diemethyl-3-hydroxy- | | ammounium |
| | 2,5-dihydrofuran-2- | | glycyrrhizinate, L-glycine, |
| | one | | L-histidine, neohesperidin |
| | | | dihydrochalchone, |
| | | | glycyrrhizin, thaumatin |
| Sucrose, HFCS, corn | Sodium chloride, | Octahydro coumarin, | l-lysine, magnesium |
| syrup, sucromalt, | sodium gluconate, | methylcyclo | gluconate, magnesium |
| isomaltulose, lactose, | sodium citrate, tannic | pentenlone, | chloride, magnesium |
| galactose, xylose, | acid, 2-ethyl-4-(H)-5- | dihydrocumarin | sulphate, thaumatin, |
| oligosaccharides, | methyl-3(2H)- | methyl coumarin, | neohesperidine, |
| fructo- | furanone, 4,5- | anise oil | dihydrochalcone, mono- |
| oligosaccharides, | diemethyl-3-hydroxy- | | ammounium |
| polydextrose, honey, | 2,5-dihydrofuran-2- | | glycyrrhizinate, L-glycine, |
| brown rice syrup, | one | | L-histidine, neohesperidin |
| agave syrup, | | | dihydrochalchone, |
| molasses, brown | | | glycyrrhizin, thaumatin |
| sugar, tagatose, | | | |
| trehalose | | | |
| APM, Ace-K, | Sodium chloride, | Octahydro coumarin, | l-lysine, magnesium |
| sucralose, saccharin, | sodium gluconate, | methylcyclo | gluconate, magnesium |
| cyclamate, neotame, | sodium citrate, tannic | pentenlone, | chloride, magnesium |
| alitame, NHDC, | acid, 2-ethyl-4-(H)-5- | dihydrocumarin | sulphate, thaumatin, |
| monatin, lo han quo, | methyl-3(2H)- | methyl coumarin, | neohesperidine, |
| extract of the fruit of | furanone, 4,5- | anise oil | dihydrochalcone, mono- |
| the Cucurbitaceae | diemethyl-3-hydroxy- | | ammounium |
| family, stevioside | 2,5-dihydrofuran-2- | | glycyrrhizinate, L-glycine, |
| | one | | L-histidine, neohesperidin |
| | | | dihydrochalchone, |
| | | | glycyrrhizin, thaumatin |

Additional taste potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meal protein and fish meat protein, egg white protein and collagen), and microbial proteins (e.g., microbial cell protein and polypeptides produced by microorganisms).

The sensation of warming or cooling effects may also be prolonged with the use of a hydrophobic sweetener as described in U.S. Patent Publication No. 2003/0072842 A1, which is incorporated in its entirety herein by reference. For example, such hydrophobic sweeteners include those of the formulae I-XI as set forth below:

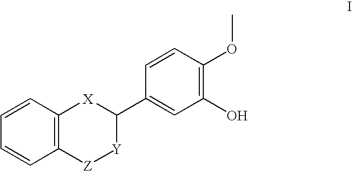

wherein X, Y and Z are selected from the group consisting of CH₂, O and S;

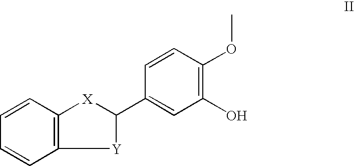

wherein X and Y are selected from, the group consisting of S and O;

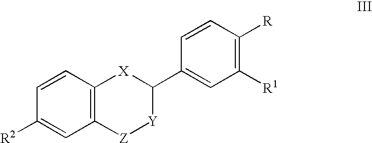

wherein X is S or O; Y is O or CH₂; Z is CH₂, SO₂ or S; R is OCH₃, OH or H; R¹ is SH or OH and R² is H or OH;

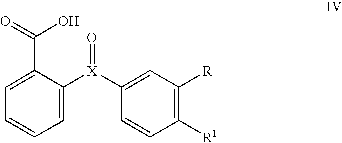

wherein X is C or S; R is OH or H and R¹ is OCH₃ or OH;

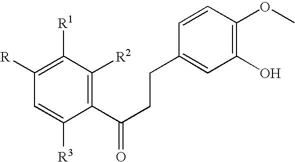

wherein R, R² and R³ are OH or H and R¹ is H or COOH;

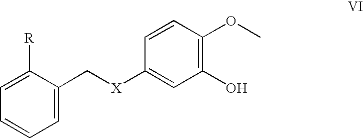

wherein X is O or CH₂ and R is COOH or H;

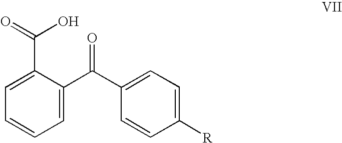

wherein R is CH₃CH₂, OH, N(CH3)₂ or Cl;

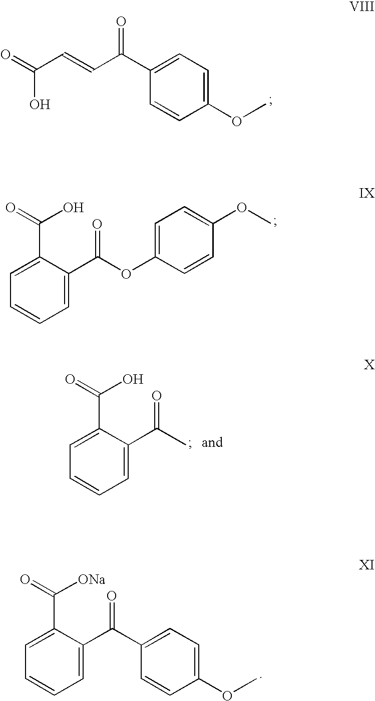

Perillartine may also be added as described in U.S. Pat. No. 6,159,509, which is incorporated in its entirety herein by reference.

Any of the above-listed taste potentiators may be used alone or in combination.

Some embodiments, for instance, may include two or more taste potentiators that act synergistically with one another. For instance, in some embodiments, a sweetness modifier composition may be provided, which includes two or more sweetness modifiers that act synergistically with one another. The sweetness modifier composition may enhance the sweetness of products into which it is incorporated by reducing the amount of sucrose needed to provide a sweetness intensity equivalent to sucrose. The sweetness enhancing effect of the combination of sweetness modifiers may be greater than the effect of either compound used individually.

The sweetness modifier composition may contain a further sweetness modifier. For instance, 3,4-dihydroxybenzoic acid (3,4-DHB) or its comestible salt may be employed.

Comestible salts of 3,4-DHB include acid (i.e. carboxylate) salts and/or hydroxylate salts, especially sodium, potassium, calcium, magnesium, and ammonium salts and the like.

The salts may be preformed or formed in the foodstuff by reaction with typical buffering agents, such as sodium phosphate, potassium citrate, sodium acetate, calcium phosphate (e.g. mono- and tricalcium phosphates) and the like which are also normally employed in foodstuffs to provide the desired pH.

The taste properties and qualities of these salts may perform better in some systems than 3,4-dihydroxybenzoic acid itself. The free acid may have some acidic and slightly astringent characteristics in some systems.

The sodium and potassium salts may be less sour and may be more tasteful with a cleaner taste overall as compared with the free acid. Salts of 3,4-DHB easily can be prepared from 3,4-dihydroxybenzoic acid by neutralizing a concentrated aqueous solution thereof with an appropriate base (for instance sodium hydroxide to prepare 3,4-DHB.Na), crystallizing the formed salt (for instance by cooling) and collecting and drying the crystals after removal of the solvent and appropriate washing.

In some embodiments, the sweetness modifier composition may be provided as a pre-blended powder or liquid, which may be added to another composition, whereas in other embodiments, the individual components of the sweetness modifier composition may be added to another composition as individual ingredients.

In some embodiments, it may be desirable to control the release rate of the taste potentiator(s) from the compositions, as well as the overall release profile of the compositions themselves. Different release rates may be desired depending on the type of final product in which the composition is being incorporated and the consumption time thereof. For instance, chewing gum products may have different chew profiles, ranging anywhere from about 15 to about 120 minutes. Depending upon the chewing gum selected, different release rates will be desired. Other confectionery formats, such as hard candy, including nougats, caramels, frappes and taffies, also may have different release rates.

In some embodiments, the release rate may be based on the solubility of the taste potentiaton(s) in water. Selection of a specific solubility may be used to control the release profile of the taste potentiator(s), as well as the overall composition. More specifically, taste potentiators have varying solubilities in water. Although some of these components are water-soluble, i.e., capable of being substantially or completely dissolvable in water, others exhibit poor or no solubility in water. In some embodiments, for instance; it may be desirable to select one or more taste potentiators that have low water-solubility in combination with an active known to exhibit poor solubility in water. The highly insoluble taste potentiator thereby may last throughout consumption of the composition as the active substance also slowly releases therefrom. Alternatively, a relatively highly water-soluble potentiator may be paired with a relatively highly water-soluble active substance. In both of these instances, the taste potentiator and active substance may be selected based on solubilities such that their release profiles are similar or overlap.

In other embodiments, for example, it may be desirable to select several taste potentiators that have different solubilities in water such that the potentiators may release sequentially from the composition. Another example may include multiple sequentially releasing taste potentiators with multiple active substances also having different solubilities in water. Numerous other combinations of taste potentiators having different solubilities also may be used to provide different release profiles for the compositions. In view thereof, the solubility of the taste potentiator(s), as well as the combination thereof with the active(s), may be used to control and tailor the release profile of the overall composition.

For purposes of some embodiments described herein, therefore, the term “controlled-release” means that the duration or manner of release is managed or modified to some degree to provide a desired release profile. More specifically, for example, controlled-release includes at least the following release profiles: delayed onset of release; pulsed release; gradual release; high initial release; sustained release; sequential release; and combinations thereof.

Taste potentiators and active substances having different solubilities and/or release profiles may be combined in numerous different embodiments to provide compositions having many different overall release profiles. For example, one or more taste potentiators having any of the following, release profiles may be combined in any manner with one or more active substances having any of the following release profiles: delayed onset of release (“DOR”); pulsed release (“PR”); gradual release (“GR”); high initial release (“HIR”); and sustained release (“SUR”). Moreover, other techniques of imparting these, as well as other controlled-release profiles to taste potentiators and/or active substances may be employed. For instance, encapsulation techniques, which are discussed in more detail below, may be used. Additionally, taste potentiator(s) and active substance(s) that are not encapsulated (sometimes referred to as “free” components) may be combined with other forms of the components, such as encapsulated forms, to tailor the release profile of the potentiator compositions. A sampling of hypothetical combinations is provided in Table 3 below, wherein P₁-P₃ represent different taste potentiators and A₁-A₃ represent different active substances. P₁-P₃ and A₁-A₃ may be used in their free and/or encapsulated forms.

TABLE 3

| Hypothetical | | | | | | |
|---|---|---|---|---|---|---|
| Combinations | P₁ | P₂ | P₃ | A₁ | A₂ | A₃ |
| 1 | GR | HIR | | GR | HIR | |
| 2 | | GR | HIR | | GR | HIR |
| 3 | PR | SUR | GR | PR | SUR | GR |
| 4 | | PR | SUR | | PR | SUR |
| 5 | HI | | PR | HI | | PR |
| 6 | DOR | HIR | | DOR | HIR | |
| 7 | | DOR | HIR | | DOR | HIR |
| 8 | | | DOR | PR | | DOR |
| 9 | SUR | HIR | | | PR | |
| 10 | | SUR | HIR | | | PR |

Controlled-release properties also may be imparted to the compositions described herein in other manners, such as, for example, by encapsulation techniques, as mentioned above. Encapsulation may be used to impart any of the various release profiles discussed above. In some embodiments, the taste potentiator(s) and/or active substance(s) may be encapsulated to control the rate of release of the potentiator and/or active from the composition. For example, in some embodiments, 3-HB and/or 2,4-DHB may be used in their encapsulated forms.

For instance, some embodiments may include at least one encapsulated taste potentiator and at least one unencapsulated active, i.e., in its free form. Other embodiments may include at least one unencapsulated taste potentiator and at least one encapsulated active substance. Further, in some embodiments, both the taste potentiator(s) and active substance(s) may be encapsulated. In such embodiments, the taste potentiator(s) and active substance(s) may be encapsulated together or separately. In embodiments in which the taste potentiator(s) and active substance(s) are encapsulated separately, the material used to encapsulate the components may be the same or different. Furthermore, in any of these embodiments, more than one material may be used to encapsulate the taste potentiator(s) or the active substance(s).

In any of the embodiments mentioned above, the encapsulated form of the taste potentiator(s) or active substance(s) may be used in combination with an amount of the same component in its free, i.e., unencapsulated, form. By using both the free component and the encapsulated component, the enhanced perception of the active may be provided over a longer period of time and/or perception of the active by a consumer may be improved. For instance, some embodiments may include a taste potentiator that is encapsulated in combination with an amount of the same taste potentiator in its unencapsulated form. Alternatively, the unencapsulated taste potentiator could be a different taste potentiator from the potentiator that is encapsulated. Thereby, a mixture of two different taste potentiators may be included in some embodiments, one of which is encapsulated and the other in its free form. These variations also may be employed with respect to the active substance(s).

Encapsulation may be effected by dispersion of the components, spray drying, spray coating, fluidized bed drying, absorption, adsorption, coacervation, complexation, or any other standard technique. In general, the taste potentiator(s) and/or active substances(s) may be encapsulated by an encapsulant. For purposes of some embodiments described herein, the term “encapsulant” refers to a material that can fully or partially coat or enrobe another substance. Encapsulation is also meant to include adsorption of a substance onto another substance and the formation of agglomerates or conglomerates between two substances.

Any material conventionally used as an encapsulant in edible products may be employed. In some embodiments, for instance, it may be desirable to use an encapsulant that delays the release of the taste potentiator(s), such as, for example, a hydrophobic encapsulant. In contrast, in other embodiments, it may be desirable to increase the rate of release by using an encapsulant such as, for example, a hydrophilic material. Moreover, more than one encapsulant may be used. For example, a taste potentiator or an active substance may be encapsulated by a mixture of two or more encapsulants to tailor the rate of release.

It is believed that taste potentiators can act in conjunction with active substances to enhance their activity. In some embodiments, therefore, it may be desirable to control the release of the potentiator(s) such that it substantially coincides with that of the active substance(s) included in the composition. As discussed above, some taste potentiators have rapid release rates, whereas other taste potentiators have slower release rates. Meanwhile, some active substances have rapid release rates, whereas others have slower release rates. In some embodiments, the material used to encapsulate the taste potentiator(s) may be selected to delay or increase the release rate of the potentiator(s) based on the release profiles of both the potentiator(s) and active substance(s) selected for use together in the composition.

More specifically, in some embodiments, the active substances) contained in the composition may have a slower release profile than the taste potentiator(s) selected for use in the same composition. It may be desirable, therefore, to delay the release of the taste potentiator(s) from the composition such that it releases substantially in conjunction with the active(s). The corresponding release profile may increase the effectiveness of the taste potentiator(s) in enhancing the perception of the active(s) throughout consumption.

Suitable encapsulants for use in delayed release embodiments include, but are not limited to, polyvinyl acetate, polyethylene, crosslinked polyvinyl pyrrolidone, polymethylmethacrylate, polylactidacid, polyhydroxyalkanoates, ethylcellulose, polyvinyl acetatephthalate, methacrylicacid-co-methylmethacrylate and combinations thereof.

In some embodiments, as mentioned above, the taste potentiator(s) may be water-soluble. For example, the following taste potentiators are water-soluble: neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), water-soluble sugar acids, potassium chloride, sodium acid sulfate, water-soluble hydrolyzed vegetable proteins, water-soluble hydrolyzed animal proteins, water-soluble yeast extracts, adenosine monophosphate (AMP), glutathione, water-soluble nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, monohydroxybenzoic acids, such as 2-hydroxybenzoic acid (2-FHB), 3-hydroxybenzoic acid (3-DHB), 4-hydroxybenzoic acid (4-HB), dihydroxybenzoic acids, such as 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), trihydroxybenzoic acids, such as 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, aminobenzoic acids, such as, 3-aminobenzoic acid (3-AB), 4-aminobenzoic acid (4-AB), hydroxydeoxybenzoins, methoxysalicylic acids (MS), methoxybenzoic acids (B), p-anisic acids and combinations thereof. Due to their water-solubility such taste potentiators may tend to release rapidly from the compositions into which they are incorporated. As such, in some embodiments, water-soluble taste potentiators may be encapsulated by an encapsulant that delays the release of the potentiator(s), as provided above.

In other embodiments, it may be desirable to increase the release of the taste potentiator(s) from the composition. For instance, the taste potentiator(s) included in the composition may have a slower release rate than the active substance(s) selected for use in combination therewith. This difference in release rates may reduce the effectiveness of the taste potentiator(s). Accordingly, such taste potentiators may be encapsulated with an encapsulant that increases the rate of the potentiator's release. Thereby, the release of the potentiator(s) and the active(s) may substantially coincide during consumption.

Suitable encapsulants for use in increased release embodiments include, but are not limited to, cyclodextrins, sugar alcohols, starch, gum arabic, polyvinylalcohol, polyacrylic acid, gelatin, guar gum, fructose and combinations thereof.

In some embodiments, as mentioned above, the taste potentiator(s) may be substantially or completely insoluble in water. For example, the following taste potentiators are substantially or completely water-insoluble: citrus aurantium, vanilla oleoresin, water insoluble sugar acids, water insoluble hydrolyzed vegetable proteins, water insoluble hydrolyzed animal proteins, water insoluble yeast extracts, insoluble nucleotides, sugarcane leaf essence and combinations thereof. Due to their poor solubility in water, such taste potentiators may tend to release slowly from the compositions. As such, in some embodiments, substantially or completely water-insoluble taste potentiators may be encapsulated by an encapsulant that increases the release of the potentiator(s), as provided above.

In accordance with the above, the encapsulated taste potentiator may include a taste potentiator and an encapsulant. The encapsulant may be selected based upon the desired release profile of the taste potentiator. In some embodiments, the taste potentiator(s) may be present in amounts of about 0.01% to about 10% by weight of the composition, more specifically about 0.1% to about 2% by weight of the composition.

In some embodiments, the encapsulant may be present in amounts of about 1% to about 95% by weight of the composition, more specifically about 5% to about 30% by weight of the composition.

In some embodiments, the encapsulated substance, i.e. encapsulated taste potentiator(s) or active(s), may have a high tensile strength, such as at least about 6,500 psi. More specifically, the tensile strength may be about 6,500 psi to about 200,000 psi. Such tensile strengths may be suitable for controlling the release of the taste potentiator(s) and/or active substance(s) in a consistent manner over an extended period of time. Tensile strengths of encapsulated substances are described in more detail in U.S. Patent Publication No. 2005/0112236 A1, the contents of which are incorporated by reference herein.

In some embodiments, the active substance(s) included in the potentiator compositions may be present in amounts of about 1% to about 95% by weight of the composition, more specifically about 5% to about 30% by weight of the composition.

The active substance(s) may be any component for which the perception is enhanced in some manner by the presence or one or more taste potentiators. Suitable active substances include, but are not limited to, compounds that provide flavor, sweetness, tartness, umami, kokumi, savory, saltiness, cooling, warmth or tingling. Other suitable actives include oral care agents, nutraceutical actives and pharmaceutical actives. Combinations of active substances also may be employed.

Compounds that provide flavor (flavorings or flavor agents), which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor: floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

Other useful flavorings include aldehydes and esters such as cinnamyl acetate, cinnamaldehyde, citral diethylaecetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral, (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, the flavor agent may be employed in either liquid form and/or dried form. When employed in the latter form, suitable drying means such as spray drying the oil may be used. Alternatively, the flavor agent may be absorbed onto water soluble materials, such as cellulose, starch, sugar, maltodextrin, gum arabic and so forth or may be encapsulated. The actual techniques for preparing such dried forms are well-known.

In some embodiments, the flavor agents may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

Compounds that provide sweetness (sweeteners or sweetening agents) may include bulk sweeteners such as sugars, sugarless bulk sweeteners, or the like, or mixtures thereof.

Suitable sugar sweeteners generally include mono-saccharides, di-saccharides and poly-saccharides such as but not limited to, sucrose (sugar), dextrose, maltose, dextrin, xylose, ribose, glucose, lactose, mannose, galactose, fructose (levulose), invert sugar, fructo oligo saccharide syrups, partially hydrolyzed starch, corn syrup solids, isomaltulose and mixtures thereof.

Suitable sugarless bulk sweeteners include sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysate, stevia and mixtures thereof.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, high-intensity sweeteners may be used. Without being limited to particular sweeteners, representative categories and examples include:

(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erythritol and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof.

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenyl glycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose or Splenda™; examples of chlorodeoxysucrose and chlorodeoxygalactosucrose derivatives include but are not limited to: 1-chloro-1′-deoxysucrose; 4-chloro-4-deoxy-alpha-D-gal actopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructofuranoside, or 4,1′-dichloro-4,1′-dideoxygalactosucrose; 1′,6′-dichloro1′,6′-dideoxysucrose; 4-chloro-4-deoxy-alpha-D-gaactopyranosyl-1,6-dichloro-1,6-dideoxy-beta-D-fructo-furanoside, or 4,1′,6′-trichloro-4,1′,6′-trideoxygalactosucrose; 4,6-dichloro-4,6-dideoxy-alpha-1-galaetopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof;

(e) protein based sweeteners such as miraculin, extracts and derivatives of extracts of Synseplum dulcificum, mabinlin, curculin, monellin, brazzein, pentadin, extracts and derivatives of extracts of Pentadiplandra brazzeana, thaumatin, thaumaoccous danielli (Thaumatin I and II) and talin;

(f) the sweetener monatin (2-hydroxy-2-(indol-3-ylmethyl)-4-aminoglutar-ic acid) and its derivatives; and

(g) the sweetener Lo han guo (sometimes also referred to as “Lo han kuo”).

The intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereto.

Compounds that provide tartness may include acidulants, such as acetic acid, adipic acid, ascorbic acid, butyric acid, citric acid, formic acid, fumaric acid, glyconic acid, lactic acid, phosphoric acid, malic acid, oxalic acid, succinic acid, tartaric acid and mixtures thereof.

Compounds that provide umami or savory flavor may include monosodium glutamate (MSG), glutamic acid, glutamates, aspartate, free amino acids, IMP (disodium 5′-inosine monophosphate) and GMP (disodium 5′-guanosine monophosphate), compounds that stimulate T1R1 and T1R3 receptors, mushroom flavor, fermented fish flavor, and muscle flavors, such as beef, chicken, pork, ostrich, venison and buffalo.

Substances that impart kokumi may include a mixture selected from: (1) gelatin and tropomyosin and/or tropomyosin peptides; (2) gelatin and paramyosin; and (3) troponin and tropomyosin and/or tropomyosin peptides, as disclosed in U.S. Pat. No. 5,679,397 to Kuroda et al., referred to above.

Compounds that provide saltiness may include conventional salts, such as sodium chloride, calcium chloride, potassium chloride, l-lysine and combinations thereof.

Compounds that provide a cooling sensation may include physiological cooling agents. A variety of well known cooling agents may be employed. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropoyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarmnan & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester. Methyl-2-isopryl-bicyclo (2.2.1), Heptane-9-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

Compounds that provide warmth (warming agents) may be selected from a wide variety of compounds known to provide the sensory signal of warning to the individual user. These compounds offer the perceived sensation of warmth, particularly in the oral cavity, and often enhance the perception of flavors, sweeteners and other organoleptic components. Useful warming agents include those having at least one allyl vinyl component, which may bind to oral receptors. Examples of suitable warming agents include, but are not limited to: vanillyl alcohol n-butylether (TK-1000, supplied by Takasago Perfumery Company Ltd., Tokyo, Japan); vanillyl alcohol n-propylether; vanillyl alcohol isopropylether; vanillyl alcohol isobutylether; vanillyl alcohol n-aminoether; vanillyl alcohol isoamyl ether; vanillyl alcohol n-hexyl ether: vanillyl alcohol methylether; vanillyl alcohol ethylether; gingerol; shogaol; paradol; zingerone; capsaicin; dihydrocapsaicin; nordihydrocapsaicin; homocapsaicin; homodihydrocapsaicin; ethanol; isopropyl alcohol; iso-amylalcohol; benzyl alcohol; glycerine; chloroform; eugenol; cinnamon oil; cinnamic aldehyde; phosphate derivatives thereof; and combinations thereof.

Compounds that provide a tingling sensation also are known and referred to as “tingling agents.” Tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and piperine; Echinacea extract; Northern Prickly Ash extract; and red pepper oleoresin. In some embodiments, alkylamides extracted from materials such as jambu or sanshool may be included. Additionally, in some embodiments, a sensation is created due to effervescence. Such effervescence is created by combining an alkaline material with an acidic material, either or both of which may be encapsulated. In some embodiments, an alkaline material may include alkali metal carbonates, alkali metal bicarbonates, alkaline earth metal carbonates, alkaline earth metal bicarbonates and mixtures thereof. In some embodiments, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,494 to Nakatsu et al., each of which is incorporated by reference herein in its entirety.

Oral care agents that may be used include those actives known to the skilled artisan, such as, but not limited to, surfactants, breath freshening agents, anti-microbial agents, antibacterial agents, anti-calculus agents, anti-plaque agents, oral malodor control agents, fluoride compounds, quaternary ammonium compounds, remineralization agents and combinations thereof.

Suitable surfactants include, but are not limited to, salts of fatty acids selected from the group consisting of C₈-C₂₄ palmitoleic acid, oleic acid, eleosteric acid, butyric acid, caproic acid, caprylic acid, capric acid, lauric acid, myristic acid, palmitic acid, stearic acid, ricinoleic acid, arachidic acid, behenic acid, lignoceric acid, cerotic acid, sulfated butyl oleate, medium and long chain fatty acid esters, sodium oleate, salts of fumaric acid, potassium glomate, organic acid esters of mono- and diglycerides, stearyl monoglyceridyl citrate, succistearin, dioctyl sodium sulfosuccinate, glycerol tristearate, lecithin, hydroxylated lecithin, sodium lauryl sulfate, acetylated monoglycerides, succinylated monoglycerides, monoglyceride citrate, ethoxylated mono- and diglycerides, sorbitan monostearate, calcium stearyl-2-lactylate, sodium stearyl lactylate, lactated fatty acid esters of glycerol and propylene glycerol, glycerol-lactoesters of C₈-C₂₄ fatty acids, polyglycerol esters of C₈-C₂₄ fatty acids, propylene glycol alginate, sucrose C₈-C₂₄ fatty acid esters, diacetyl tartaric and citric acid esters of mono- and diglycerides, triacetin, sarcosinate surfactants, isethionate surfactants, tautate surfactants, pluronics, polyethylene oxide condensates of alkyl phenols, products derived from the condensation of ethylene oxide with the reaction product of propylene oxide and ethylene diamine, ethylene oxide condensates of aliphatic alcohols, long chain tertiary amine oxides, long chain tertiary phosphine oxides, long chain dialkyl sulfoxides, and combinations thereof.

Suitable antibacterial agents include, but are not limited to, chlorhexidine, alexidine, quaternary ammonium salts, benzethonium chloride, cetyl pyridinium chloride, 2,4,4′-trichloro-2′-hydroxy-diphenyl ether (triclosan) and combinations thereof.

Suitable fluoride compounds include, but are not limited to, sodium fluoride, sodium monofluorophosphate, stannous fluoride and combinations thereof.

Suitable anti-calculus agents include, but are not limited to, pyrophosphates, triphosphates, polyphosphates, polyphosphonates, dialkali metal pyrophosphate salt, tetra alkali polyphosphate salt, tetrasodium pyrophosphate, tetrapotassium pyrophosphate, sodium tripolyphosphate and combinations thereof.

Suitable anti-microbial agents include, but are not limited to, cetylpyridinium chloride, zinc compounds, copper compounds and combinations thereof.

Suitable remineralization agents include, but are not limited to casein phosphopeptide-amorphous calcium phosphate, casein phosphoprotein-calcium phosphate complex, casein phosphopeptide-stabilized calcium phosphate, and combinations thereof.

Other oral care actives known to those skilled in the art are considered well within the scope of the present invention.

Pharmaceutical actives include drugs or medicaments, breath fresheners, vitamins and other dietary supplements, minerals, caffeine, nicotine, fruit juices, and the like, and mixtures thereof. Examples of useful drugs include ace-inhibitors, antiangina drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra®, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

In some embodiments, a mixture of at least one active substance and at least one taste potentiator is encapsulated, rather than encapsulating the taste potentiator or the active substance alone. Similar to above, the encapsulant may be selected to delay or increase the rate of release of the mixture of components. Any of the encapsulants described above may be employed.

For example, in some embodiments, the active substance(s) may be at least one intense sweetener. The intense sweetener(s) may be mixed with at least one taste potentiator, which is selected to increase the sweet taste of the intense sweetener(s). This mixture of components may then be encapsulated. Examples of suitable intense sweeteners include, but are not limited to, neotame, aspartame, Acesulfame-K, sucralose, saccharin and combinations thereof.

In embodiments including an encapsulated mixture of active(s) and potentiator(s), the active substance(s) may be present in amounts of about 1% to about 95% by weight of the composition, more specifically about 5% to about 30% by weight. The taste potentiator(s) may be present in amounts of about 0.01% to about 12% by weight of the composition, more specifically about 0.1% to about 5% by weight. The encapsulant may be present in amounts of about 1% to about 95% by weight of the composition, more specifically about 10% to about 60% by weight.

As mentioned above, some embodiments may include a mixture of at least one encapsulated taste potentiator and at least one taste potentiator in its free form. The encapsulated and unencapsulated taste potentiators may be the same or different. The encapsulated taste potentiator(s) may be encapsulated by any of the materials described above. The mixture of encapsulated and unencapsulated taste potentiators may be combined with one or more active substances to provide a potentiator composition.

Some other embodiments provide compositions that modulate the activity of taste receptor cells in a mammal. Such compositions may include at least one active substance and at least one taste potentiator, as described above. These components may be encapsulated or unencapsulated, also as described above. The taste potentiator(s) may modulate the activity of taste receptor cells upon consumption of the composition. More specifically, taste is perceived through sensory cells located in the taste buds. Different signaling mechanisms sense the primary tastes of salty, sour, sweet, bitter and umami. Eventually a nerve impulse is triggered in the brain that is sensed as one of these primary tastes.

Taste potentiators function by modulating the activity of taste receptor cells at some point in this taste signaling pathway. For instance, in some cases, taste potentiators may bind to taste receptors, such as, for example, sweet taste receptors, which thereby enhances the perception of the sweet taste. In other embodiments, for example, taste potentiators may block taste receptors, such as, for example bitter receptors, which suppress the perception of a bitter taste and thereby enhances the perception of a sweet taste. Taste potentiator(s), therefore, modulate the activity of taste receptor cells in mammals, which thereby enhances the perception of a given taste. This activity may enhance the perception of an active substance contained in the composition when consumed in conjunction with a taste potentiator.

### Edible Orally Delivered Products

In some embodiments, the potentiator compositions may reside in an orally delivered product including at least one active substance and at least one taste potentiator.

The orally delivered product may be a foodstuff; pharmaceutical or personal care product. Preferred foodstuffs include confectionery, especially chocolates, hard boilings and other sugar-based candies, jellies, gummies, soft candies, edible films, lozenges, pressed tablets, cereal bars, chewing gum, and the like. Pharmaceuticals may be delivered in the form of a tablet, capsule, solution, tincture, linctus or syrup. Confectionery and solid pharmaceutical delivery forms optionally can be coated. Exemplary personal products include toothpaste, mouth spray, and mouth wash.

In some embodiments, the orally delivered product may be a frozen or refrigerated/perishable food product. Such frozen or refrigerated food products may include, but are not limited to, frozen desserts, frozen confections, yogurts, puddings, frozen baked goods, whipped toppings and condiments, such as, ketchup, tabletop sweeteners, mustard, mayonnaise, salsas, chutneys, hummus, marinades, and relish.

In still other embodiments, sweetened orally delivered products may include jams, jellies, peanut butter, syrups, toppings, fruit or vegetable sauces such as apple sauce or spaghetti sauce, baked goods, such as cookies, cakes, and bread, sweet and salty snacks, such as sweetened roasted nuts, kettle corn, barbeque potato snacks, and dry or powder mixes such as pudding mix, hot chocolate mix, fruit juice mix, drink mix lemonade mix, and the like.

In other embodiments, the orally delivered product may be a beverage. Such beverages may include soft or carbonated drinks, juice-based drinks, milk-based drinks, beverages made from brewed components such as teas and coffees, beverage mixes, beverage concentrates, powdered beverages, beverage syrups, frozen beverages, gel beverages, alcoholic beverages, and the like.

In some embodiments, the orally delivered product may include a confectionery base or gum base and any of the potentiator compositions described herein. In some embodiments, some or all of the active and/or the taste potentiator may be employed in a free form (e.g., unencapsulated). Alternatively, the product may include some or all of the active and/or the taste potentiator in an encapsulated form. As a further alternative, the product may include some of the active and/or the taste potentiator in a free form and some of the active and/or the taste potentiator in an encapsulated form. In some embodiments, the product may include two or more potentiator compositions.

The required concentrations will depend upon the nature of the orally delivered product to be sweetened, the level of sweetness required, the nature of the sweetener(s) in the product and the degree of enhancement required.

### Confectionery Compositions

When the orally delivery product is a confectionery composition, the product may be a comestible selected from forms such as, but not limited to, hard candy, soft candy, center-fill candy, cotton candy, pressed tablets, edible film, lozenges, and the like.

Confectionery compositions may include a confectionery base and any of the potentiator compositions described above, which may include at least one active substance such as a sweetener and at least one taste potentiator such as a sweetness modifier. The confectionery compositions also may include a variety of optional additives, as provided in more detail below. Upon consumption, the composition containing the active(s) and the taste potentiator(s) releases from the confection and provides an enhanced perception of the active(s) contained therein.

For example, in some embodiments, the active substance may be at least one sweetener, such as, a sugar sweetener, sugarless bulk sweetener, intense sweetener or any combination thereof. In general, the active substance(s) may be present in amounts of about 0.0001% to about 75% by weight of the confectionery composition. In some embodiments, which include actives other than intense sweeteners, the active substance(s) may be present in amounts of about 25% to about 75% by weight of the confectionery composition. The taste potentiator(s) may be present in amounts of about 0.01% to about 10% by weight of the confectionery composition.

Some embodiments are directed to a comestible in the form of a lozenge or candy, also commonly referred to as confectioneries. Such confectionery compositions may include a confectionery base including bulk sweeteners such as sugars and sugarless bulk sweeteners, or the like, or mixtures thereof. Bulk sweeteners generally are present in amounts of about 0.05% to about 99% by weight of the composition.

A variety of traditional ingredients also may be included in the confectioneries in effective amounts such as coloring agents, antioxidants, preservatives, sweeteners, and the like. Coloring agents may be used in amounts effective to produce the desired color. The coloring agents may include pigments which may be incorporated in amounts up to about 6%, by weight of the composition. For example, titanium dioxide may be incorporated in amounts up to about 2%, and preferably less than about 1%, by weight of the composition. The colorants may also include natural food colors and dyes suitable for food, drag and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No. 2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino)diphenylmethylene]-[1-(N-ethyl-N-p-sulfoniumbenzyl)-delta-2,5-cyclohexadieneimine]. A full recitation of all F.D.& C. colorants and their corresponding chemical strictures may be found in the Kirk-Othmer Encyclopedia of Chemical Technology, 3rd Edition, in volume 5 at pages 857-884, which text is incorporated herein by reference.

Lubricants also may be added in some embodiments to improve the smoothness of the comestible, such as, for example hard candy embodiments. Smoothness also is a characteristic that leads to an increased perception of hydration upon consumption. Suitable lubricants include, but are not limited to, fats, oils, aloe vera, pectin and combinations thereof.

Similarly, in some embodiments, the comestible may have smooth edges. In such embodiments, the comestible may have any shape, such as square, circular or diamond-shaped, however, the edges are rounded to provide a smooth comestible. Another manner of lending smoothness to the comestibles is to deposit the comestible composition into moulds during the manufacturing process. Accordingly, in some embodiments, the comestible is deposited, as described in more detail below.

In some embodiments, the confectionery composition may further include a sweetener selected from Lo han guo, stevia, monatin and combinations thereof.

Other conventional additives known to one having ordinary skill in the art also may be used in the confectionery compositions.

In some embodiments, confectionery compositions may be produced by batch processes. Such confections may be prepared using conventional apparatus such as fire cookers, cooking extruders, and/or vacuum cookers. In some embodiments, the bulk sweetener (sugar or sugar free) and a solvent (e.g., water), are combined in a mixing vessel to form a slurry. The slurry is heated to about 70° C. to 120° C. to dissolve any sweetener crystals or particles and to form an aqueous solution. Once dissolved, heat and vacuum are applied to cook the batch and boil off water until a residual moisture of less than about 4% is achieved. The batch changes from a crystalline to an amorphous, or glassy, phase. The potentiator composition then may be admixed in the batch by mechanical mixing operations, along with any other optional additives, such as coloring agents, flavorants, and the like. The batch is then cooled to about 50° C. to 10° C. to attain a semisolid or plastic-like consistency.

The optimum mixing required to uniformly mix the actives, potentiators, and other additives during manufacturing of hard confectionery is determined by the time needed to obtain a uniform distribution of the materials. Normally, mixing times of from four to ten minutes have been found to be acceptable. Once the candy mass has been properly tempered, it may be cut into workable regions or formed into desired shapes having the correct weight and dimensions. A variety of forming techniques may be utilized depending upon the shape and size of the final product desired. Once the desired shapes are formed, cool air is applied to allow the comestibles to set uniformly, after which they are wrapped and packaged.

Alternatively, various continuous cooking processes utilizing thin film evaporators and injection ports for incorporation of ingredients including the potentiator compositions are known in the art and may be used as well.

The apparatus useful in accordance with some embodiments comprise cooking and mixing apparatus well known in the confectionery manufacturing arts, and selection of specific apparatus will be apparent to one skilled in the art.

Additionally, in some embodiments, various confectionery configurations with multiple regions may be employed. These configurations may include, but are not limited to, liquid center-fill, powder center-fill, hard coated, soft coated, laminated, layered and enrobed. In some embodiments, the potentiator composition may be included in one region or in multiple regions of the product.

### Soft Confectionery Compositions

In some embodiments, the orally delivered product may be in the form of various soft confectionery formats. Soft confectionery formats may include, but are not limited to, nougat, caramel, taffy, gummies and jellies.

Soft confectionery compositions may include a confectionery base and any of the potentiator compositions described above, which may include at least one active substance such as a sweetener and at least one taste potentiator such as a sweetness modifier. The soft confectionery compositions also may include a variety of optional additives, such as any of the additives set forth above in the section describing confectionery compositions. Upon consumption, the composition containing the active(s) and the taste potentiator(s) releases from the soft confection and provides an enhanced perception of the active(s) contained therein.

For example, in some embodiments, the active substance may be at least one sweetener, such as, a sugar sweetener, sugarless bulk sweetener, intense sweetener or any combination thereof. In general, the active substance(s) may be present in amounts of about 0.0001% to about 75% by weight of the soft confectionery composition. In some embodiments, which include actives other than intense sweeteners, the active substance(s) may be present in amounts of about 25% to about 75% by weight of the soft confectionery composition. The taste potentiator(s) may be present in amounts of about 0.01% to about 10% by weight of the soft confectionery composition.

Some soft confectionery compositions include nougat compositions, which may include two principal components, a high-boiled candy and a frappe. By way of example, egg albumen or substitute thereof is combined with water and whisked to form a light foam. Sugar and glucose are added to water and boiled typically at temperatures of from about 130° C. to 140° C. and the resulting boiled product is poured into a mixing machine and beaten until creamy. The beaten albumen and flavoring agent are combined with the creamy product and the combination is thereafter thoroughly mixed.

In some embodiments, a caramel composition may include sugar (or sugar substitute), corn syrup (or polyol syrup), partially hydrogenated fiat, milk solids, water, butter, flavors, emulsifiers, and salt. To prepare the caramel, the sugar/sugar substitute, corn syrup/polyol syrup, and water may be mixed together and dissolved over heat. Then, the milk solids may be mixed in to the mass to form a homogeneous mixture. Next, the minor ingredients may be mixed in with low heat. The heat then may be increased to boiling. Once sufficient water is removed and color/flavor developed, the mass may be cooled somewhat and temperature sensitive ingredients (including some potentiators) may be mixed in prior to discharging and forming/shaping/wrapping the finished product.

In some embodiments, a taffy composition may include sugar (or sugar substitute), corn syrup (or polyol syrup), partially hydrogenated fat, water, flavors, emulsifiers, and salt. The process for preparing taffy can be similar to that for caramel and, optionally, the final taffy mass may be pulled to develop its desired texture.

In some embodiments, a gummi composition may include sugar (or sugar substitute), corn syrup (or polyol syrup), gelatin (or suitable hydrocolloid), flavor, color, and optionally acid. The gummi may be prepared by hydrating the gelatin or suitable hydrocolloid, heating the sugar/corn syrup (sugar substitute/polyol syrup) and combining the two components with heat. Once the combined mixture reaches its final temperature or suitable sugar solids level, components such as flavor, color, and the like may be incorporated into the mixture and then poured into molds prior to cooling, wrapping, and finishing. Various surface treatments such as applications of wax or fat can be applied to decrease sticking.

In some embodiments, a jelly composition may include a starch-based jelly or a pectin-based jelly. As with gummis, jelly products may be produced by hydrating the hydrocolloid and combining the hydrated mixture with a cooked syrup component. The mixture then may be cooked to a final moisture content and minor components may be incorporated. As with gummis, jelly candies may be poured into molds such as starch molds. As with gummis, surface treatments, such as fiats or waxes, may be applied. Additionally, jelly candies may have dry surface treatments, such as applications of sanding sugar, acid, non-pareils, and the like.

Additionally, in some embodiments, various soft confectionery configurations with multiple regions may be employed. These configurations may include, but are not limited to, liquid center-fill, powder center-fill, hard coated, soft coated, laminated, layered and enrobed. In some embodiments, the potentiator composition may be included in one region or in multiple regions of the product.

### Chewing Gum Compositions

Some embodiments provide chewing gum compositions for delivery of the potentiator compositions described above. Such chewing gum compositions may include a gum base and any of the potentiator compositions described above, which may include at least one active substance such as a sweetener and at least one taste potentiator such as a sweetness modifier. The chewing gum compositions also may include a variety of optional additives, as provided in more detail below. Upon consumption, the composition containing the active(s) and the taste potentiator(s) releases from the chewing gum and provides an enhanced perception of the active(s) contained therein.

As described in detail above, in some embodiments, the potentiator composition generally includes at least one active substance and at least one taste potentiator. In some embodiments, the taste potentiator(s) and/or active(s) may be encapsulated, as described above, or a mixture of the active(s) and taste potentiator(s) may be encapsulated. These components may be selected from any of those described above. For example, in some embodiments, the active substance may be at least one sweetener, such as, a sugar sweetener, sugarless bulk sweetener, intense sweetener or any combination thereof. In general, the active substance(s) may be present in amounts of about 0.0001% to about 75% by weight of the chewing gum composition. In some embodiments, which include actives other than intense sweeteners, the active substance(s) may be present in amounts of about 25% to about 75% by weight of the chewing gum composition. The taste potentiator(s) may be present in amounts of about 0.01% to about 10% by weight of the chewing gum composition.

In some embodiments, the chewing gum composition may include multiple taste potentiators. The taste potentiators may be encapsulated or unencapsulated and may be the same or different. In some embodiments, the multiple taste potentiators may be different. Some chewing gum compositions, for instance, may include one or more taste potentiators that are encapsulated in combination with one or more different taste potentiators that are unencapsulated. In some embodiments, two different encapsulated taste potentiators may be used in a chewing gum composition. Alternatively, in some other embodiments, the chewing gum composition may include a combination of the same taste potentiator in its encapsulated and free forms.

The chewing gum composition also may include a gum base. The gum base may include any component known in the chewing gum art. Such components may be water soluble, water-insoluble or a combination thereof. For example, the gum base may include elastomers, bulking agents, waxes, elastomer solvents, emulsifiers, plasticizers, fillers and mixtures thereof.

The elastomers (rubbers) employed in the gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and mixtures thereof. Examples of synthetic elastomers include, without limitation, styrene-butadiene copolymers (SBR), polyisobutylene, isobutylene-isoprene copolymers, polyethylene, polyvinyl acetate and the like, and mixtures thereof.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10% to about 60% by weight, desirably from about 35% to about 40% by weight.

In some embodiments, the gum base may include wax. It softens the polymeric elastomer mixture and improves the elasticity of the gum base. When present, the waxes employed will have a melting point below about 60° C., and preferably between about 45° C. and about 55° C. The low melting wax may be a paraffin wax. The wax may be present in the gum base in an amount from about 6% to about 10%, and preferably from about 7% to about 9.5%, by weight of the gum base.

In addition to the low melting point waxes, waxes having a higher melting point may be used in the gum base in amounts up to about 5%, by weight of the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum base in amounts from about 2% to about 15%, and preferably from about 7% to about 11%, by weight of the gum base.

The gum base may also include emulsifiers which aid in dispersing the immiscible components into a single stable system. The emulsifiers useful in this Invention include glycerol monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base. The plasticizers and softeners are generally employed in the gum base in amounts up to about 20% by weight of the gum base, and more specifically in amounts from about 9% to about 17%, by weight of the gum base.

Plasticizers also include hydrogenated vegetable oils, such as soybean oil and cottonseed oils, which may be employed alone or in combination. These plasticizers provide the gum base with good texture and soft chew characteristics. These plasticizers and softeners are generally employed in amounts from about 5% to about 14%, and more specifically in amounts from about 5% to about 13.5%, by weight of the gum base.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts. Preferably the amount of filler, when used, will be present in an amount from about 15% to about 40%, and desirably from about 20% to about 30%, by weight of the gum base.

A variety of traditional ingredients may be optionally included in the gum base in effective amounts such as flavor agents and coloring agents, antioxidants, preservatives, and the like. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, vitamin E and mixtures thereof, may also be included. Other conventional chewing gum additives known to one having ordinary skill in the chewing gum art may also be used in the gum base.

The chewing gum compositions may include amounts of conventional additives selected from the group consisting of sweetening agents, plasticizers, softeners, emulsifiers, waxes, fillers, bulking agents (carriers, extenders bulk sweeteners), mineral adjuvants, flavor agents and coloring agents, antioxidants, acidulants, thickeners, medicaments, oral care actives, such as remineralization agents, antimicrobials and tooth whitening agents, as described in assignee's co-pending U.S. patent application Ser. No. 10/901,511, filed on Jul. 29, 2004 and entitled “Tooth Whitening Compositions and Delivery Systems Therefor,” which is incorporated herein by reference in its entirety, and the like, and mixtures thereof. Some of these additives may serve more than one purpose. For example, in sugarless gum compositions, a sweetener, such as maltitol or other sugar alcohol, may also function as a bulking agent.

Bulk sweeteners include sugars, sugarless bulk sweeteners, or the like, or mixtures thereof. Bulk sweeteners generally are present in amounts of about 5% to about 99% by weight of the chewing gum composition. Suitable sugar sweeteners and sugarless bulk sweeteners, as well as intense sweeteners are provided above in the description of the potentiator compositions.

In general, an effective amount of intense sweetener may be utilized to provide the level of sweetness desired, and this amount may vary with the sweetener selected. The intense sweetener may be present in amounts from about 0.001% to about 3%, by weight of the chewing, gum composition, depending upon the sweetener or combination of sweeteners used. The exact range of amounts for each type of sweetener may be selected by those skilled in the art.

In some embodiments, the chewing gum composition may include a sweetener selected from Lo han guo, stevia, monatin and combinations thereof.

Any of the flavor agents discussed above as being suitable for use in the potentiator compositions also may be used in the chewing gum compositions. In chewing gum compositions, flavor agents generally may be present in amounts from about 0.02% to about 5%, and more specifically from about 0.1% to about 4%, and even more specifically, from about 0.8% to about 3%, by weight of the composition.

Coloring agents may be used in amounts effective to produce the desired color. The coloring agents may include pigments which may be incorporated in amounts up to about 6%, by weight of the composition. For example, titanium dioxide may be incorporated in amounts up to about 2%, and preferably less than about %, by weight of the composition. The colorants may also include natural food colors and dyes suitable for food, drug and cosmetic applications. Suitable coloring agents are set forth above in the description of confectionery compositions.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glyceryl monostearate, thickeners, used alone or in combination with other softeners, such as methyl cellulose, alginates, carrageenan, xanthan gum, gelatin, carol, tragacanth, locust bean, and carboxy methyl cellulose, acidulants such as malic acid, adipic acid, citric acid, tartaric acid, fumaric acid, and mixtures thereof, and fillers, such as those discussed above under the category of mineral adjuvants.

Other conventional gum additives known to one having ordinary skill in the chewing gum art also may be used in the chewing gum compositions.

In some embodiments, the potentiator composition included in the chewing gum composition may include at least one active substance having a first solubility and at least one taste potentiator having a second solubility. The first and second solubilities may be substantially similar or different and may be selected to provide a controlled-release profile to the chewing gum composition. In particular, the selected solubilities may provide one of the following release profiles: simultaneous release, sequential release or partially overlapping release.

Some embodiments extend to methods of preparing a chewing gum product. The products may be prepared using standard techniques and equipment known to those skilled in the art. The apparatus useful in accordance with the embodiments described herein includes mixing and heating apparatus well known in the chewing gum manufacturing arts, and therefore the selection of the specific apparatus will be apparent to the artisan. For general chewing gum preparation processes see U.S. Pat. Nos. 4,271,197 to Hopkins et al, 4,352,822 to Cherukuri et al and 4,497,832 to Cherukuri et al, each of which is incorporated herein by reference in its entirety.

More specifically, in accordance with some embodiments, at least one encapsulant and at least one taste potentiator may be mixed to form a dispersion of the components. In particular, the encapsulant(s) may be melted at elevated temperatures in a high shear mixer. The potentiator(s) may be added to the molten encapsulant and mixed under high shear to completely disperse the components. The components may be mixed at elevated temperatures of about 50-150° C. The resulting mixture of components may be cooled. A plurality of encapsulated taste potentiator particles subsequently may be formed from the mixture. The particles may be formed to an appropriate size as desired, generally from an average particle size range of about 50 μm to about 800 μm. This may be accomplished by any suitable means such as chopping, pulverizing, milling or grinding the particles.

Alternatively, the encapsulated particles may be prepared by spray drying methods. More specifically, the encapsulant(s) may be dissolved in water. In some embodiments, this solution may be prepared in an agitated vessel. The taste potentiator(s) then may be dispersed in the solution. The solution, or suspension, may be spray dried using a spray dryer fitted with an air atomized nozzle at elevated temperatures to form the encapsulated particles.

In other embodiments, the encapsulated particles may be prepared by any suitable spray coating method as known in the art. One suitable process is the Wurster process. This process provides a method for encapsulating individual particulate materials. First, the particles to be encapsulated are suspended in a fluidizing air stream, which provides a generally cyclic flow in front of a spray nozzle. The spray nozzle sprays an atomized flow of the coating solution, which may include the encapsulant(s) and a suitable solvent. The atomized coating solution collides with the particles as they are carried away from the nozzle to provide a particle coating with the coating solution. The temperature of the fluidizing air stream, which also serves to suspend the particles to be coated, may be adjusted to evaporate the solvent shortly after the coating solution contacts the particles. This serves to solidify the coating on the particles, resulting in the desired encapsulated particle.

In some embodiments, at least one active substance may be combined in the first step of the process along with the encapsulant(s) and the taste potentiator(s) to form a dispersion of all the components. The active substance(s) thereby may be encapsulated with the taste potentiator(s) to form an encapsulated mixture of the components.

Once the encapsulated particles are obtained, they may be added to a chewing gum composition. Such encapsulated particles also may be added to confectionery compositions to prepare any of the confectionery products described above. The chewing gum composition may be prepared using standard techniques and equipment, as described above. The encapsulated particles may be added to the chewing gum composition to enhance the perception of at least one active substance contained therein, which may be any of the actives described above. Once the encapsulated particles are mixed into the chewing gum composition, individual chewing gum pieces may be formed using standard techniques known in the chewing gum art. For instance, chewing gum pieces may be prepared in the form of a slab, pellet, stick, center-fill gum, deposited, compressed chewing gum or any other suitable format.

For instance, center-fill chewing gum embodiments may include a center-fill region, which may be a liquid or powder or other solid, and a gum region. Some embodiments also may include an outer gum coating or shell, which typically provides a crunchiness to the niece when initially chewed. The outer coating or shell may at least partially surround the gum region. The potentiator compositions described above may be incorporated into any of the regions of the center-fill chewing gum, i.e., the center-fill region, gum region and/or outer coating of the gum. Alternatively, the taste potentiator(s) may be incorporated into one region while the active substance(s) is incorporated into a different region of the center-fill gum. Upon consumption, the taste-potentiator(s) and active(s) may release from the different regions and combine as the gum is chewed. Center-fill chewing gums and methods of preparing same are more fully described in assignee's co-pending U.S. patent application Ser. No. 10/925,822, filed on Aug. 24, 2004 and assignee's co-pending U.S. patent application Ser. No. 11/210,954, filed on Aug. 24, 2005, both entitled “Liquid-Filled Chewing Gum Composition,” the contents both of which are incorporated herein by reference.

Some other chewing gum embodiments may be in a compressed gum formal, such as, for example, a pressed tablet gum. Such embodiments may include a particulate chewing gum base, which may include a compressible gum base composition and a tableting powder, and any of the potentiator compositions described above. In such embodiments, the potentiator composition may be in a powdered form. Compressed chewing gums are more fully described in assignee's co-pending U.S. Provisional Application No. 60/734,680, filed on Nov. 8, 2005, and entitled “Compressible Gum System,” the contents of which are incorporated herein by reference.

In some embodiments, the chewing gum may have a coating thereon. Such coated chewing gums are typically referred to as pellet gums. The outer coating may be hard or crunchy. Any suitable coating materials known to those skilled in the art may be employed. Typically, the outer coating may include sorbitol, maltitol, xylitol, isomalt, erythritol and other crystallizable polyols; sucrose may also be used. Furthermore the coating may include several opaque layers, such that the chewing gum composition is not visible through the coating itself, which can optionally be covered with a further one or more transparent layers for aesthetic, textural and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colorants may be added. A polyol coating can be further coated with wax. The coating can further include colored flakes or speckles. If the composition includes a coating, it is possible that one or more oral care actives can be dispersed throughout the coating. This is especially preferred if one or more oral care actives is incompatible in a single phase composition with another of the actives. Flavors may also be added to yield unique product characteristics.

Other materials may be added to the coating to achieve desired properties. These materials may include without limitations, cellulosics such as carboxymethyl cellulose, gelatin, xanthan gum and sum arabic.

The coating composition may be applied by any method known in the art including the method described above. The coating composition may be present in an amount from about 2% to about 60%, more specifically from about 25% to about 45% by weight of the total chewing gum piece.

Similarly, some embodiments extend to methods of preparing a taste potentiator composition having controlled-release upon consumption. In accordance therewith, at least one taste potentiator may first be provided. The taste potentiator(s) may be mixed with an encapsulant to form a composition having a dispersion of the components. Once the components are fully dispersed, a plurality of encapsulated taste potentiator particles may be formed from the composition, as described above. As a consequence of the encapsulation, the release rate of the potentiator(s) will be modified. The material for use as the encapsulant may be selected to provide either a delayed or increased release rate of the potentiator(s) upon consumption of the composition.

### Beverage Compositions

In some embodiments, the potentiator compositions may reside in a beverage composition including at least one active substance such as a sweetener and at least one taste potentiator such as a sweetness modifier. Beverages suitable for use herein include, for example, soft or carbonated drinks, juice-based drinks, milk-based drinks, beverages made from brewed components such as teas and coffees, beverage mixes, beverage concentrates, powdered beverages, beverage syrups, frozen beverages, gel beverages, alcoholic beverages, and the like.

The beverages may include any of the potentiator compositions described herein. In general, the potentiator compositions are present in the beverage compositions in amounts of about 0.001% to about 0.100%, more specifically about 0.02% to about 0.08%, and even more specifically about 0.04% to about 0.06% by weight of the beverage composition.

Of course, the required concentrations will depend upon the nature of the beverage to be sweetened the level of sweetness required, the nature of the sweetener(s) in the product and the degree of enhancement required.

In some embodiments, some or all of the active and/or the taste potentiator may be employed in a free form (e.g., unencapsulated). Alternatively, the beverage composition may include some or all of the active and/or the taste potentiator in an encapsulated form. As a further alternative, the beverage composition may include some of the active and/or the taste potentiator in a free form and some of the active and/or the taste potentiator in an encapsulated form. In some embodiments, the beverage composition may include two or more potentiator compositions.

### Juice-Based Compositions:

Juice-based compositions generally contain a juice component obtained from fruit or vegetable. The juice component can be used in any form such as a juice form, a concentrate, an extract, a powder, or the like.

Suitable juices include, for example, citrus juice, non-citrus juice, or mixtures thereof, which are known for use in beverages. Examples of such juices include, non-citrus juices such as apple juice, grape juice, pear juice, nectarine juice, currant juice, raspberry juice, gooseberry juice, blackberry juice, blueberry juice, strawberry juice, custard-apple juice, pomegranate juice, guava juice, kiwi juice, mango juice, papaya juice, watermelon juice, cantaloupe juice, cherry juice, cranberry juice, peach juice, apricot juice, plum juice, and pineapple juice; citrus juices such as orange juice, lemon juice, time juice, grapefruit juice, and tangerine juice; and vegetable juice such as carrot juice and tomato juice; or a combination comprising at least one of the foregoing juices.

Unless otherwise indicated, juice as used can include fruit or vegetable liquids containing a percentage of solids derived from the fruit or vegetable, for example pulp, seeds, skins, fibers, and the like, and pectin, which is naturally occurring in the fruit or vegetable. The amount of solids in the juice can be about 1 to about 75 wt %, specifically about 5 to about 60 wt %, more specifically about 10 to about 45 wt %, and vet more specifically about 15 to about 30 wt % each based on the total weight of the juice. Higher concentrations of solids can be found in juice concentrates, purees, and the like.

The amount of juice component present in the juice-based composition generally can be about 0.1 wt % to about 95 wt % based on the total weight of the composition, specifically about 5 wt % to about 75 wt %, and more specifically about 10 wt % to about 50 wt % each based on the total weight of the composition. Amounts may vary depending upon whether the composition is a concentrate or a ready to drink beverage, for example. The remaining components in the juice-based composition can be added water or other suitable liquid, a sweetening agent, a flavoring agent, or other additives as described herein.

The juice-based composition can be non-carbonated or carbonated.

In one embodiment, the juice-based composition is fortified with solubilized calcium in the form of calcium carbonate, calcium oxide, or calcium hydroxide, for example. A food-grade acid is added to the calcium fortified juice-based composition to improve the solubility of calcium. Exemplary food-grade acids suitable for use in the juice-based composition are further discussed herein, specifically citric acid, malic acid, or a combination comprising at least one of the foregoing food-grade acids.

In some embodiments, the juice-based composition can be formed from a fruit or vegetable using a hot break or cold break process. In both processes, the fruit or vegetable is macerated and passed through conventional equipment to separate out seeds, skins and other undesired solids. The composition is then concentrated by conventional techniques. In hot break processes, the fruit or vegetable is typically heated during maceration or immediately thereafter to deactivate enzymes that may degrade the product and decrease the viscosity of the product. In cold break processes, the fruit or vegetable typically are processed at lower temperatures than hot break. A hot break process accordingly may provide a thicker product than those produced by a cold break process.

In one embodiment, the juice-based composition is pasteurized to destroy unwanted microorganisms. Suitable pasteurization conditions of juice-based compositions can be selected by one of ordinary skill in the art without undue experimentation using the guidelines provided. An exemplary pasteurization process to sterilize the juice-based composition is by heating the composition to about 60 to about 80° C. for about 6 to about 15 minutes in an aseptic environment.

In another embodiment, the juice-based composition is filled into a beverage container and then subjected to pasteurization conditions. Alternatively, the composition is hot-filled into a beverage container at temperatures sufficient to sterilize the composition in the container.

In another embodiment, the juice-based composition can contain a preservative allowing the composition to be cold-filled into a beverage container without the need for pasteurization. Specifically, the preservatives can be added to lower the pH level of the beverage to pH of about 3 to about 4.5. Suitable preservatives are discussed in detail herein.

### Milk-Based Compositions:

Milk-based compositions generally contain a dairy component which can contain varying amounts of milk proteins (e.g., casein, whey protein, and the like), fats, lactose, and water. Exemplary dairy components include yogurt, cream, whole milk, low or reduced fat milk, skim milk, milk solids, condensed milk, or a combination comprising at least one of the foregoing dairy components.

In some embodiments, non-dairy components may replace part or all of the dairy components in the milk-based composition. Suitable non-dairy components include soy milk, almond milk, coconut milk, rice milk, and the like, or a combination comprising at least one of the foregoing.

Stabilizers can be added to the milk-based composition to prevent precipitation. Exemplary stabilizers include hydrocolloids such as pectin, propylene glycol alginate, and the like, as well as the stabilizers described further herein.

The amount of milk proteins in a milk-based beverage composition can be about 0.1% to about 10% by weight based on the total weight of the milk-based beverage composition, specifically about 0.5% to about 5% by weight, and more specifically about 1.0% to about 4% by weight.

The milk-based composition can contain a sweetening agent, coloring agent, or other additives as disclosed herein. The milk-based composition can be non-carbonated or carbonated.

In some embodiments, the milk-based beverage is lactose free.

The process for preparing milk-based beverage compositions generally includes mixing and emulsifying a dairy component or non-dairy component with an emulsifier to form an emulsified component. The emulsified component can be pasteurized, cooled, and blended with a second component, which can contain a flavoring agent, a sweetening agent, other additives, or water or other suitable liquid to form a beverage composition. The blending can be performed under aseptic conditions to ensure product integrity.

Suitable conditions for the pasteurization of milk-base compositions can be selected by one of ordinary skill in the art without undue experimentation using the guidelines provided. An exemplary pasteurization process to sterilize the emulsified component or other dairy component can be effected at temperatures of about 130 to about 140° C. for about 30 seconds to about 2 minutes in an aseptic environment. Alternatively, the pasteurization can be performed at about 115 to about 125° C. for about 20 to about 30 minutes in an aseptic environment.

In another embodiment, the milk-based composition is filled into a beverage container and then subjected to the pasteurization conditions.

### Alcoholic Compositions:

The compositions described herein may further comprise an alcoholic composition. Examples of suitable alcoholic compositions include beer, spirit, liqueur, wine, or a combination comprising at least one of the foregoing. In some embodiments, the level of alcohol, as measured by the amount of ethanol contained in the beverage composition can be about 0.5 vol % to about 20 vol % based on the total volume of the beverage composition.

### Carbonated Compositions:

A carbonated beverage composition typically contains about 0.1 to about 5.0 volumes of gas or gasses, typically carbon dioxide, oxygen, nitrogen, nitrous oxide, and mixtures thereof per volume of the beverage composition. In some embodiments, a mixture of gasses such as carbon dioxide and nitrous oxide may be used. The carbonation can be effected by forceful introduction of the gas or gasses under pressure to the beverage composition. Cooling the beverage composition allows for greater amounts of carbon dioxide and/or other gasses to be solubilized by the beverage composition. Carbonation can be used to enhancing the flavor, sweetness, taste, and mouth-feel of the composition. Additionally, carbonation lowers the pH of the composition.

The salts may be preformed or formed in the foodstuff by reaction with typical buffering agents, such as sodium phosphate, potassium citrate, sodium acetate, calcium phosphate (e.g. mono- and tricalcium phosphates) and the like which are also normally employed in foodstuffs to provide the desired pH.

For instance, beverages sweetened according to the present invention provide a syrupy, rounded sweetness profile similar to products sweetened with sucrose, whereas beverages sweetened by APM alone have a more lingering sweetness profile. Although blends of APM and Ace-K can have a more sugar-like sweetness/time profile than APM alone, such blends still lack the sucrose-like mouthfeel of the present invention.

### Food Products:

In some embodiments, the potentiator compositions may reside in a sweetened orally delivered product such as a rood product. In some embodiments, these sweetened orally delivered products may include at least one active substance such as a sweetener and at least one taste potentiator such as a sweetness modifier. Sweetened orally delivered products suitable for use herein include, for example, cereal bars, frozen desserts, frozen confections, yogurts, puddings, frozen baked goods, whipped toppings and condiments, such as, ketchup, tabletop sweeteners, mustard and relish, jams, jellies, peanut butter, syrups, toppings, sauces such as apple sauce, baked goods, such as cookies, cakes, and bread, sweet and salty snacks, such as sweetened roasted nuts, kettle corn, barbeque potato snacks, and dry or powder mixes such as pudding mix, and the like.

The compositions as described herein may include table top sweeteners. The table top sweetener may include artificial sweeteners and sweetness modifiers.

The compositions as described herein may include sweetened yogurts. The sweetened yogurt may include yogurt, fruit, starch, flavors, food acids, artificial sweeteners and sweetness modifiers.

The compositions as described herein may include sweetened fruit sauces, such as apple sauce. The sweetened fruit sauce may include fruit, water, sweeteners, artificial sweeteners and sweetness modifiers.

The compositions as described herein may include sweetened cookies. The sweetened cookie may include flour, fats such as butter, shortening or margarine, eggs, baking powder, sweeteners, artificial sweeteners and sweetness modifiers.

The compositions as described herein may include sweetened cakes. The sweetened cake may include flour, water, eggs, fats such as butter, shortening or margarine, milk, baking powder, salt, sweeteners, artificial sweeteners and sweetness modifiers.

The compositions as described herein may include sweetened condiments, such as ketchup. The sweetened condiment may include water, fruit or vegetable purees, vinegar, salt, starches, spices, sweeteners, artificial sweeteners and sweetness modifiers.

The compositions as described herein may include sweetened dry or powder mixes, such as pudding. The sweetened mix may include flavor, salt, starches, surfactants sweeteners, artificial sweeteners and sweetness modifiers.

The methods of preparing any of the food products include any of those known to one of ordinary skill in the art.

In some embodiments, the sweetness modifiers may be added to a flavor component of the food product.

The features and advantages of the present invention are more fully shown by the following examples which are provided for purposes of illustration, and are not to be construed as limiting the invention in any way.

### EXAMPLES

### Example 1

A table top sweetener composition was prepared according to the formulation in Table 2 below.

TABLE 2
Table Top Sweeteners

| | A | B |
|---|---|---|
| | Comparative | Inventive |
| Components | (% w/w) | (% w/w) |
| Maltodextrin | 98.84 | 87.05 |
| Sucralose | 1.16 | 0.51 |
| 2,4-dihydroxybenzoic acid | — | 6.22 |
| 3-hydroxybenzoic acid | — | 6.22 |

The table top sweetener was prepared by weighing the ingredients into a glass beaker and mixing well. Once mixed, the table top sweetener may be added to coffee or tea, or simply sprinkled over breakfast cereal.

As shown in Comparative Example A and Inventive Example B above, the control only contains maltodextrin and sucralose. These components act as the active ingredient, or sweeteners, in this example. Example B additionally includes 2,4-dihydroxybenzoic acid and 3-hydroxybenzoic acid, which act as the sweetness modifiers. The combination including maltodextrin and sucralose plus the modifiers 2,4-dihydroxylbenzoic acid and 3-hydroxybenzoic provides the table top sweetener with an increase in sucrose equivalence value. Therefore, although the composition of Example B includes lower levels of the two sweeteners than A, the addition of the sweetness modifiers provides Example B with a comparable or greater sweetness perception upon consumption.

Upon tasting, the inventive composition demonstrated an increased sweetness intensity as compared to the control composition.

### Example 2

A table top sweetener composition is prepared according to the formulation in Table 3 below.

TABLE 3
Table Top Sweeteners

| | C | D | E | F |
|---|---|---|---|---|
| | Comparative | Comparative | Inventive | Inventive |
| Components | (% w/w) | (% w/w) | (% w/w) | (% w/w) |
| Maltodextrin | 98.84 | | 98.84 | |
| Lactose | | 95 | | 95 |
| Aspartame | 1.16 | 5 | 1.02 | 4.4 |
| 3-aminobenzoic acid | | | 0.14 | 0.6 |

The table top sweetener is prepared by weighing the ingredients into a glass beaker and mixing well. Once mixed, the table top sweetener may be added to coffee or tea, or simply sprinkled over breakfast cereal.

As shown in Comparative Examples C and D and Inventive Examples E and F above, the control only contains aspartame and maltodextrin, or lactose. Aspartame acts as the active ingredient, or sweetener, in this example. Examples E and F additionally include 3-aminobenzoic acid, which acts as the sweetness modifier. The combination including aspartame plus the modifier 3-aminobenzoic acid will provide the table top sweetener with an increase in sucrose equivalence value. Therefore, although the composition of Examples E and F include lower levels of the sweetener than C or D, the addition of the sweetness modifier provides Examples E and F with a comparable or greater sweetness perception upon consumption.

### Example 3

A table top sweetener composition is prepared according to the formulation in Table 4 below.

TABLE 4
Table Top Sweeteners

| | G | H | I | J |
|---|---|---|---|---|
| | Comparative | Comparative | Inventive | Inventive |
| Components | (% w/w) | (% w/w) | (% w/w) | (% w/w) |
| Maltodextrin | 98.84 | | 98.84 | |
| Lactose | | 95 | | 95 |
| Sucralose | 1.16 | 5 | 1.02 | 4.4 |
| 3-aminobenzoic | | | 0.14 | 0.6 |
| acid | | | | |

The table top sweetener is prepared by weighing the ingredients into a glass beaker and mixing well. Once mixed, the table top sweetener may be added to coffee or tea, or simply sprinkled over breakfast cereal.

As shown in Comparative Examples G and H and Inventive Examples 1 and 3 above, the control only contains sucralose and maltodextrin or lactose. The sucralose acts as the active ingredient, or sweetener, in this example. Examples I and J additionally include 3-aminobenzoic acid, which acts as the sweetness modifier. The combination including sucralose plus the modifier 3-aminobenzoic acid will provide the table top sweetener with an increase in sucrose equivalence value. Therefore, although the compositions of Examples I and J include lower levels of the sweetener than G or H, the addition of the sweetness modifiers provides Examples I and J with a comparable or greater sweetness perception upon consumption.

### Example 4

A sweetened yogurt composition was prepared according to the formulation in Table 5 below.

TABLE 5
Strawberry Yogurt (no added sugar)

| | K | L |
|---|---|---|
| | Comparative | Inventive |
| Components | (% w/w) | (% w/w) |
| Yogurt (0.1% fat) | 84.967 | 84.926 |
| Strawberries | 10.050 | 10.050 |
| Water | 4.395 | 4.395 |
| Modified Starch | 0.450 | 0.450 |
| Flavor | 0.080 | 0.080 |
| Citric Acid | 0.020 | 0.020 |
| Aspartame | 0.030 | 0.015 |
| Acesulfame-K | 0.008 | 0.004 |
| 3-hydroxybenzoic acid | — | 0.050 |
| 3,4-dihydroxybenzoic acid | — | 0.010 |

The strawberry yogurt was prepared by first incorporating a slurry starch into a portion of the water. Next, the strawberries, remaining water and citric acid were added into a bain-marie. The combination then was heated to 65° C. The starch slurry then was added to the fruit, water, citric acid mixture. The combination then was heated to 90° C. for one minute. Color, flavor, sweeteners and hydroxybenzoic acids then were added. The combination then was mixed thoroughly and cooled in a refrigerator. The fruit preparation then was mixed with the yogurt in a 85:15 ratio.

As shown in Comparative Example K and Inventive Example L above, the control only contains aspartame and acesulfame-K. These components act as the active ingredient, or sweeteners, in this example. Example L additionally includes 3-hydroxybenzoic acid and 3,4-dihydroxybenzoic acid, which act as the sweetness modifiers. The combination including aspartame and acesulfame-K plus the modifiers 3-hydroxybenzoic acid and 3,4-dihydroxybenzoic acid will provide the yogurt with an increase in sucrose equivalence value. Therefore, although the composition of Example L includes lower levels of the two sweeteners than Example K, the addition of the sweetness modifiers provides Example L with a comparable or greater sweetness perception upon consumption.

Upon tasting, the inventive composition demonstrated an increased sweetness intensity as compared to the control composition.

### Example 5

A sweetened fruit sauce composition was prepared according to the formulation in Table 6 below.

TABLE 6
Apple Sauce

| | M | N |
|---|---|---|
| | Comparatively | Inventive |
| Components | (% w/w) | (% w/w) |
| Apples | 80.00 | 80.00 |
| Sucrose | 9.00 | 6.00 |
| 3-hydroxybenzoic acid | — | 0.05 |
| 3,4-dihydroxybenzoic acid | — | 0.01 |
| Water | 11.00 | 13.94 |

The apples were peeled and chopped. The apples then were placed in a saucepan. The remaining ingredients were placed in the saucepan. The combination of apples, sucrose, 3-hydroxybenzoic acid and 3,4-dihydroxybenzoic acid and water were placed over medium heat, and continuously stirred for 10 minutes. The combination then was cooled in the refrigerator.

As shown in Comparative Example M and Inventive Example N above, the control only contains sucrose. This component acts as the active ingredient, or sweetener, in this example. Example N additionally includes 3-hydroxybenzoic acid and 3,4-dihydroxybenzoic acid, which act as the sweetness modifiers. The combination including sucrose plus the modifiers 3-hydroxybenzoic acid and 3,4-dihydroxybenzoic acid will provide apple sauce with an increase in sucrose equivalence value. Therefore, although the composition of Example N includes lower levels of the sweetener than Example N4, the addition of the sweetness modifiers provides Example N with a comparable or greater sweetness perception upon consumption.

Upon tasting, the inventive composition demonstrated an increased sweetness intensity as compared to the control composition.

### Example 6

A sweetened cookie composition was prepared according to the formulation in Table 7 below.

TABLE 7
Cookies (No added sugar)

| | O | P |
|---|---|---|
| | Comparative | Inventive |
| Components | (% w/w) | (% w/w) |
| Biscuit flour | 37.9800 | 37.9100 |
| Cake margarine | 30.9000 | 30.9000 |
| Whole egg | 15.4500 | 15.4500 |
| Baking powder | 0.1300 | 0.1300 |
| Polydextrose | 15.4200 | 15.4200 |
| Aspartame | 0.1234 | 0.0926 |
| 2,4-dihdroxybenzoic acid | | 0.0500 |
| 3,4-dihydroxybenzoic acid | | 0.0500 |

The margarine and polydextrose were blended until creamy with an electric mixer for one minute. The egg was added and the mixture was beat for 45 seconds with the electric mixer. The flour, baking powder, aspartame and hydroxybenzoic acids were combined in a separate bowl. The flour mixture was slowly added to the margarine mixture, while mixing for one minute. Once all the ingredients were combined, the entire mixture was whisked for one minute at the highest speed. The cookies were placed on a greased baking tray and baked at 180° C. for approximately 15 minutes.

As shown in Comparative Example O and Inventive Example P above, the control only contains polydextrose and aspartame. These components act as the active ingredient, or sweeteners, in this example. Example P additionally includes 2,4-dihydroxybenzoic acid and 3,4-dihydroxybenzoic acid act as the sweetness modifiers. The combination including polydextrose and aspartame plus the modifiers 2,4-dihydroxybenzoic acid and 3,4-dihydroxybenzoic acid will provide the cookie with an increase in sucrose equivalence value. Therefore, although the composition of Example P includes lower levels of the two sweeteners than Example O, the addition of the sweetness modifiers provides Example P with a comparable or greater sweetness perception upon consumption.

Upon tasting, the inventive composition demonstrated an increased sweetness intensity as compared to the control composition.

### Example 7

A sweetened cake composition was prepared according to the formulation in Table 8 below.

TABLE 8
Cakes (Control and 50% reduced sugar)

| | Q | R |
|---|---|---|
| | Comparative | Inventive |
| Components | (% w/w) | (% w/w) |
| Cake flour | 20.48 | 20.37 |
| Caster sugar | 25.85 | 12.93 |
| Water | 18.62 | 18.62 |
| Egg | 18.20 | 18.20 |
| High ratio shortening | 13.44 | 13.44 |
| Polydextrose | — | 12.93 |
| Skim milk powder | 1.66 | 1.66 |
| Baking powder | 1.24 | 1.24 |
| Salt | 0.31 | 0.31 |
| Potassium sorbate | 0.20 | 0.20 |
| 2,4-dihydroxybenzoic acid | — | 0.05 |
| 3-hydroxybenzoic acid | — | 0.05 |

The oven was preset to 170° C. The following ingredients were added to a planetary mixer bowl: cake flour, caster sugar, high ratio shortening, polydextrose, skim milk powder, baking powder, salt, potassium sorbate, 2,4-dihydroxybenzoic acid and 3-hydroxybenzoic acid. The water then was added. The combination was mixed using a K-beater at speed 1 for 30 seconds. The bowl then was scraped. The combination then was mixed at speed 3 for 30 seconds. The bowl then was scraped. The egg was added to the combination, while the combination was mixed at speed 1 for 30 additional seconds. The bowl then was scraped. The final mixture then was mixed at speed 2 until specific gravity was equal to 0.8. The mixture then was placed in a cake pan and baked at 170° C. for 30 minutes.

As shown in Comparative Example Q and Inventive Example R above, the control only contains sugar. This component acts as the active ingredient, or sweetener, in the control example. The test example contains both sugar as the active ingredient and polydextrose functions as a bulking agent to replace the mass lost due to sucrose reduction. 2,4-dihydroxybenzoic acid and 3-hydroxybenzoic acid act as the sweetness modifiers. The combination including sugar plus the modifiers 2,4-dihydroxybenzoic acid and 3-hydroxybenzoic acid will provide the cake with an increase in sucrose equivalence value. Therefore, although the composition of Example R includes tower levels of sucrose than Example Q, the addition of the sweetness modifiers provides Example R with a comparable or greater sweetness perception upon consumption.

Upon tasting, the inventive composition demonstrated an increased sweetness intensity as compared to the control composition.

### Example 8

A sweetened condiment composition was prepared according to the formulation in Table 9 below.

TABLE 9
Tomato Ketchup (control and 50% reduced sugar)

| | S | T |
|---|---|---|
| | Comparative | Inventive |
| Components | (% w/w) | (% w/w) |
| Water | 34.70 | 40.64 |
| Tomato puree | 27.00 | 27.00 |
| Vinegar | 14.20 | 14.20 |
| Sucrose | 18.00 | 12.00 |
| Salt | 2.50 | 2.50 |
| Modified starch | 3.30 | 3.30 |
| Mixed Spice | 0.30 | 0.30 |
| 3-Hydroxybenzoic acid | — | 0.05 |
| 3,4-Dihydroxybenzoic acid | — | 0.01 |

The following ingredients were combined into a mixing bowl: sucrose, salt, modified starch, mixed spice, 3-hydroxybenzoic acid and 3,4-dihydroxybenzoic acid. Water, tomato puree and vinegar were placed in a bain-marie. The dry mixture was stirred into the water, puree and vinegar mixture. The mixture then was heated to 85° C. for 3 minutes and stirred constantly. Water lost during heating then was added to the mixture. The mixture then was cooled.

As shown in Comparative Example S and Inventive Example T above, the control only contains sucrose. This component acts as the active ingredient, or sweetener, in the control example. Example T additionally includes 3-hydroxybenzoic acid and 3,4-dihydroxybenzoic aced, which act as the sweetness modifiers. The combination including sucrose plus the modifiers 3-hydroxybenzoic acid and 3,4-dihydroxybenzoic acid will provide the ketchup with an increase in sucrose equivalence value. Therefore, although the composition of Example T includes lower levels of the sweetener than Example S, the addition of the sweetness modifiers provides Example T with a comparable or greater sweetness perception upon consumption.

Upon tasting, the inventive composition demonstrated an increased sweetness intensity as compared to the control composition.

### Example 9

A sweetened beverage composition was prepared according to the formulation in Table 10 below.

TABLE 10
Chocolate Milk (no added sugar)

| | U | V |
|---|---|---|
| | Comparative | Inventive |
| Components | (% w/w) | (% w/w) |
| Skim milk | 98.9700 | 98.8730 |
| Sucralose | 0.0100 | 0.0066 |
| Cocoa Powder | 1.0000 | 1.0000 |
| Carrageenan | 0.0200 | 0.0200 |
| 2,4-Dihydroxybenzoic acid | — | 0.0500 |
| 3,4-Dihydroxybenzoic acid | — | 0.0500 |

The following ingredients were mixed together to form a dry blend: sucralose, cocoa powder and carrageenan. The milk was placed in a plastic beaker. The dry blend was sheared into the milk using a high shear mixer at 5000-6000 rpm for one minute. The mixture was transferred into a bain-marie. The mixture then was heated for five minutes at 90° to pasteurize the mixture. Water lost during heating was added back to the mixture. The mixture was transferred to a clean beaker and allowed to cool. Once cooled, the mixture was sheared for two minutes at 5000 rpm. The mixture then was transferred into plastic bottles.

As shown in Comparative Example U and Inventive Example V above, the control only contains sucralose. This component acts as the active ingredient, or sweetener, in the control example. Example V additionally includes 2,4-dihydroxybenzoic acid and 3,4-dihydroxybenzoic acid, which act as the sweetness modifiers. The combination including sucralose plus the modifiers 2,4-dihydroxybenzoic acid and 3,4-dihydroxybenzoic acid will provide the chocolate milk with an increase in sucrose equivalence value. Therefore, although the composition of Example V includes lower levels of the sweetener than Example U, the addition of the sweetness modifiers provides Example V with a comparable or greater sweetness perception upon consumption.

Upon tasting, the inventive composition demonstrated an increased sweetness intensity as compared to the control composition.

### Example 10

A sweetened flavored alcoholic beverage composition was prepared according to the formulation in Table 11 below.

TABLE 11
Flavored Alcoholic Beverage (control and 33% reduced sugar)

| | W | X |
|---|---|---|
| | Comparative | Inventive |
| Components | (% w/w) | (% w/w) |
| Water | 77.658 | 80.208 |
| Vodka (37.5% abv) | 14.130 | 14.130 |
| Sucrose | 7.600 | 5.000 |
| Malic acid | 0.362 | 0.362 |
| Flavor | 0.150 | 0.100 |
| Color | 0.100 | 0.100 |
| 3-Hydroxybenzoic acid | — | 0.050 |
| 3,4-Dihydroxybenzoic acid | — | 0.050 |

The ingredients were added to a volumetric flask. The flask then was mixed to dissolve the ingredients.

As shown in Comparative Example W and Inventive Example X above, the control only contains sucrose. This component acts as the active ingredient, or sweetener, in the control example. Example X additionally includes 3-hydroxybenzoic acid and 3,4-dihydroxybenzoic acid, which act as the sweetness modifiers. The combination including sucrose plus the modifiers 3-hydroxybenzoic acid and 3,4-dihydroxybenzoic acid will provide the flavored alcoholic beverage with an increase in sucrose equivalence value. Therefore, although the composition of Example X includes lower levels of the sweetener than Example W, the addition of the sweetness modifiers provides Example X with a comparable or greater sweetness perception upon consumption.

Upon tasting, the inventive composition demonstrated an increased sweetness intensity as compared to the control composition.

### Example 11

A sweetened carbonated beverage composition is prepared according to the formulation in Table 12 below.

TABLE 12
Carbonated Beverage Containing Sweetener Potentiator(s)

| | Y | Z |
|---|---|---|
| | Inventive | Inventive |
| Component | % (w/v) | % (w/v) |
| High fructose corn syrup | 45.0 | 45.0 |
| Lemon-lime flavor | 0.75 | |
| Citric Acid | 1.1 | 0.5 |
| Sodium citrate | 0.15 | |
| Sweetener potentiator(s) | 0.5 | 0.5 |
| Dicalcium sodium EDTA | 0.018 | |
| Sodium benzoate | 0.13 | 0.13 |
| Cola Flavor | | 1.1 |
| Phosphoric acid 80% | | 1.5 |
| Caramel Color | | 0.5 |
| Caffeine | | 0.1 |
| Water | q.s. | q.s |

Beverage compositions are prepared according to the formulations in Table 12 above. The inventive compositions contain a combination of any of the sweetener potentiators listed in Table 1 above.

The high fructose corn syrup for each composition is weighed directly into a volumetric flask. The sweetener potentiator(s) are added and washed into the flask. Then, the flavor(s), acid(s), buffer(s), color(s), and other ingredients are added and washed in with water. The flask is shaken well. Water is added to just below the fill line of the flask. Sodium benzoate solution is added. The volume then is made up with water. The syrup is carbonated in 250 ml bottles using 50 ml of the syrup and 200 ml carbonated water.

### Example 12

A sweetened juice-based beverage composition is prepared according to the formulation in Table 13 below.

TABLE 13
Juice-Based Beverage Containing Sweetener Potentiators

| | AA |
|---|---|
| | Inventive |
| Component | % (w/v) |
| Sucrose | 3.000 |
| Citric acid | 0.200 |
| Sodium citrate | 0.040 |
| Sweetener potentiator(s) | 0.100 |
| Apple juice concentrate | 1.167 |
| Natural berry flavor | 0.200 |
| Water | q.s. |

Beverage compositions are prepared according to the formulations in Table 13 above. Table 13 provides the amount in grams for each component in the formulations based on a volume of 100 ml. The inventive beverage composition contains sweetener potentiator(s), whereas the control does not contain the sweetness potentiators.

All components listed in Table 13, including the sweetener potentiator(s) in the inventive composition, except the flavor are weighed and added into a volumetric flask for each composition. The flask is filled to volume with water and placed on a magnetic stirrer until all components are fully dissolved for each composition. The contents of the flask for each composition then are transferred to a plastic beaker and heated in a microwave to 90° C. The batch then is allowed to cool to 60° C. and the flavor is added while stirring. The batch is filled into 1 liter bottles and allowed to cool in a refrigerator.

### Example 13

A sweetened iced tea beverage composition is prepared according to the formulation in Table 14 below.

### Table 14

### Iced Tea Beverage Containing Sweetness Potentiators

TABLE 14
Iced Tea Beverage Containing Sweetness Potentiators

| | BB |
|---|---|
| | Inventive |
| Component | % w/v |
| Sucrose | 7.000 |
| Citric acid | 0.200 |
| Tea extract “Assam” | 0.120 |
| Lemon Juice Concentrate | 0.100 |
| Sodium benzoate (20% solution) | 0.075 |
| Sweetener potentiator(s) | 0.10 |
| Water | q.s. |

Beverage compositions were prepared according to the formulations in Table 14 above.

All components, including the sweetness potentiators in the Inventive composition, except sodium benzoate are weighed and added into a volumetric flask using a funnel for each composition. The flask for each composition is filled with water almost to the fill line and then the sodium benzoate is added. The flask is filled with water to the fill line and inverted. If necessary, the flask is placed on a magnetic stirrer until all components are fully dissolved for each composition.

### Example 14

A sweetened powdered drink composition was prepared according to the formulation in Table 15 below.

TABLE 15
Low Calorie Hot Chocolate (11 g dry mix + 180 ml boiling water)

| | CC | DD |
|---|---|---|
| | Comparative | Inventive |
| Components | (% w/w) | (% w/w) |
| Creamer | 36.360 | 36.360 |
| Whey powder | 16.610 | 15.874 |
| Cocoa powder | 22.730 | 22.730 |
| Skim milk powder | 15.000 | 15.000 |
| Maltodextrin | 2.550 | 2.550 |
| Salt | 2.270 | 2.270 |
| Carrageenan | 2.270 | 2.270 |
| Sodium caseinate | 1.820 | 1.820 |
| Aspartame | 0.260 | 0.150 |
| Acesulfame-K | 0.130 | 0.076 |
| 2,4-Dihydroxybenzoic acid | — | 0.450 |
| 3-Hydroxybenzoic acid | — | 0.450 |

The ingredients were blended together. Once blended, 11 grams of the mixture were placed in a bleaker. 180 ml of boiling water was added to the ingredients. The combination was stirred until the ingredients were dissolved.

As shown in Comparative Example C and Inventive Example DD above, the control only contains aspartame and acesulfame-K. These components act as the active ingredient, or sweeteners, in the control example. Example DD additionally includes, 2,4-dihydroxybenzoic acid and 3-hydroxybenzoic acid, which act as the sweetness modifiers. The combination including aspartame and acesulfame-K plus the modifiers 2,4-dihydroxybenzoic acid and 3-hydroxybenzoic acid will provide the low calorie hot chocolate with an increase in sucrose equivalence value. Therefore, although the composition of Example DD includes lower levels of the two sweeteners than Example CC, the addition of the sweetness modifiers provides Example DD with a comparable or greater sweetness perception upon consumption.

Upon tasting, the inventive composition demonstrated an increased sweetness intensity as compared to the control composition.

### Example 15

A sweetened powdered drink composition was prepared according to the formulation in Table 16 below.

TABLE 16
Instant Lemon Drink (1.44 g in 200 ml cold water)

| | EE | FF |
|---|---|---|
| | Comparative | Inventive |
| Components | (% w/w) | (% w/w) |
| Citric acid | 41.67 | 41.67 |
| Lemon juice solids | 23.61 | 23.61 |
| Maltodextrin | 22.60 | 15.30 |
| Tricalcium phosphate | 2.78 | 2.78 |
| Flavor | 6.94 | 6.94 |
| Ascorbic acid | 0.83 | 0.83 |
| Color | 0.11 | 0.11 |
| Sucralose | 0.42 | 0.42 |
| Acesulfame-K | 1.04 | — |
| 3-Hydroxybenzoic acid | — | 4.17 |
| 2,4-Dihydroxybenzoic acid | — | 4.17 |

The ingredients were blended together. Once mixed, 1.44 grams of the mixture were placed in a bleaker. 200 ml of cold water was added to the ingredients. The combination was stirred until the ingredients were dissolved.

As shown in Comparative Example EE and Inventive Example FF above, the control only contains maltodextrin, sucralose and acesulfame-K. These components act as the active ingredient, or sweeteners, in the control example. In the test example, the acesulfame-K is eliminated and maltodextrin and sucralose are the only active ingredients. Furthermore, Example FF additionally includes 3-hydroxybenzoic acid and 2,4-dihydroxybenzoic acid, which act as the sweetness modifiers. The combination including maltodextrin and sucralose plus the modifiers 2,4-dihydroxybenzoic acid and 3-hydroxybenzoic acid will provide the instant lemon drink with an increase in sucrose equivalence value. Therefore, although the composition of Example FF eliminates acesulfame-K and includes lower levels of the sweeteners than Example EE, the addition of the sweetness modifiers provides Example FF with a comparable or greater sweetness perception upon consumption.

Upon tasting, the inventive composition demonstrated an increased sweetness intensity as compared to the control composition.

### Example 16

A sweetened mix composition was prepared according to the formulation in Table 17 below.

TABLE 17
Instant Chocolate Pudding (16.6 g in 200 ml cold milk)

| | GG | HH |
|---|---|---|
| | Comparative | Inventive |
| Components | (% w/w) | (% w/w) |
| Modified starch | 42.10 | 42.10 |
| Cocoa powder | 24.06 | 24.06 |
| Maltodextrin | 24.06 | 23.39 |
| Xanthan gum | 2.41 | 2.41 |
| Salt | 2.41 | 2.41 |
| Disodium phosphate | 1.20 | 1.20 |
| Lecithin | 1.80 | 1.80 |
| Aspartame | 0.46 | 0.23 |
| Flavor | 1.50 | 1.50 |
| 2,4-Dihydroxybenzoic acid | — | 0.450 |
| 3,4-Dihydroxybenzoic acid | — | 0.450 |

The ingredients were blended together. 200 ml of cold milk was placed in a mixing bowl. 16.6 grams of the dry mixture were added to the cold milk. The combination was whisked for 2 minutes with an electric mixer. The mixture then was cooled in a refrigerator.

As shown in Comparative Example GG and Inventive Example HH above, the control only contains maltodextrin and aspartame. These components act as the active ingredient, or sweetener, in the control example. In the test example, the amount of aspartame and maltodextrin were reduced. Furthermore, Example HH additionally includes 2,4-dihydroxybenzoic acid and 3,4-dihydroxybenzoic acid, which act as the sweetness modifiers. The combination including maltodextrin and aspartame plus the modifiers 2,4-dihydroxybenzoic acid and 3,4-dihydroxybenzoic acid will provide the instant chocolate pudding with an increase in sucrose equivalence value. Therefore, although the composition of Example HH includes lower levels of the sweeteners than Example GG, the addition of the sweetness modifiers provides Example HH with a comparable or greater sweetness perception upon consumption.

Upon tasting, the inventive composition demonstrated an increased sweetness intensity as compared to the control composition.

### Example 17

### Center-Fill Confectionery Composition

A sweetened center-fill confectionery composition is prepared by combining the components as set forth in Examples II-JJ in Table 18. The amounts included are based on the weight percent of the total center-fill composition.

TABLE 18
Center-fill Composition

| | II | JJ |
|---|---|---|
| | Control | Test |
| Components | (% w/w) | (% w/w) |
| Sugar | 42-48 | 42-48 |
| Corn Syrup | 42-48 | 42-48 |
| Guar Gum | 0.1-0.7 | 0.1-0.7 |
| Citric Acid | 0.7-4.5 | 0.7-4.5 |
| Flavor | 0.05-.30 | 0.05-.30 |
| Color | 0.1-0.7 | 0.1-0.7 |
| 3-Hydroxybenzoic acid | — | 0.03-0.09 |
| 3,4-Dihydroxybenzoic acid | — | 0.03-0.09 |

The sweetened gummy candy shell composition is prepared by combining the components as set forth in Examples KK-LL in Table 19. The amounts included are based on the weight percent of the total gummy candy shell composition.

TABLE 19
Gummy Candy Shell Composition

| | KK | LL |
|---|---|---|
| | Control | Test |
| Components | (% w/w) | (% w/w) |
| Sugar | 15-25 | 15-25 |
| Corn Syrup | 30-45 | 30-45 |
| Citric Acid | 0.5-1.5 | 0.5-1.5 |
| Gelatin | 7-12 | 7-12 |
| Pectin | 0.8-1.5 | 0.8-1.5 |
| Color | 0.1-0.7 | 0.1-0.7 |
| Flavor | 0.05-0.30 | 0.05-0.30 |
| 3-Hydroxybenzoic acid | — | 0.03-0.09 |
| 2,4-Dihydroxybenzoic acid | — | 0.03-0.09 |

The sweetened coating composition in particulate form is prepared by combining the components as set forth in Examples MM-NN in Table 20. The amounts included are based on the weight percent of the total coating composition,

TABLE 20
Coating Composition

| | MM | NN |
|---|---|---|
| | Control | Test |
| Components | (% w/w) | (% w/w) |
| Corn Syrup | 75-85 | 75-85 |
| Sugar | | |
| Polyol | 5-15 | 5-15 |
| Free Lactic Acid | 1-3 | 1-3 |
| Free Malic Acid | 3-5 | 3-5 |
| Encapsulated Citric Acid¹ | 5-15 | 5-15 |
| 3-Hydroxybenzoic acid | | 0.03-0.09 |
| 3,4-Dihydroxybenzoic acid | | 0.03-0.09 |

¹Encapsulated citric acid includes 90% citric acid encapsulated in hydrogenated vegetable oil made by spray chilling with an average particle size of 100 microns.

Any of the center-fill compositions of Examples II-JJ are incorporated into any of the gummy candy shell compositions of KK-LL and then any of the coating compositions of Examples MM-NN are applied to the exterior. The center-fill is added in an amount from about 5% by weight to about 25% by weight of the total composition. The gummy candy shell is added in an amount from about 70% by weight to about 90% by weight of the total composition and the coating is added in an amount from about 5% by weight to about 15% by weight of the total composition.

### Example 18

A sweetened chewing gum composition is prepared according to the formulation in Table 21 below.

The gum composition is prepared by combining the components as set forth in Examples OO-PP in Table 21. The amounts included are based on the weight percent of the total gum region composition.

TABLE 21
Chewing Gum Composition

| | OO | PP |
|---|---|---|
| | Control | Test |
| Components | (% w/w) | (% w/w) |
| Gum base* | 28-42 | 28-42 |
| Lecithin | 0.05 | 0.05 |
| Erythritol | 15-30 | 15-30 |
| Sugar | 20-40 | 20-40 |
| Corn Syrup | 2-15 | 2-15 |
| Flavors | 2.26 | 2.26 |
| Intense sweetener | 3.40 | 3.40 |
| 3-Hydroxybenzoic acid | | 0.03-0.09 |
| 3,4-Dihydroxybenzoic acid | | 0.03-0.09 |

*gum base may include 3% to 11% by weight of a filler such as, for example, talc, dicalcium phosphate, and calcium carbonate (the amount of filler in the gum base is based on the weight percent of the gum region composition, for example, in the above compositions Y-FF, if a gum region composition includes 5% filler, the amount of gum base will be 5% less than the range recited in the table, i.e., from 23-37%)

The compositions for the chewing gums are prepared by first combining talc, where present, with the gum base under heat at about 85° C. This combination is then mixed with the bulk sweeteners, lecithin, and sweetener syrups for six minutes. The flavor blends which include a pre-mix of the flavors and cooling agents are added and mixed for 1 minute. Finally, the acids, intense sweeteners, and, optionally, the sweetness modifiers are added and mixed for 5 minutes.

Any of the coating compositions of Examples MM-NN are applied to the exterior of any of the chewing gum compositions of OO-PP as described above. The chewing gum composition is added in an amount from about 85% by weight to about 95% by weight of the total composition and the coating is added in an amount from about 5% by weight to about 15% by weight of the total composition.

1. A sweetener composition, comprising:
a. at least one sweetener having a sucrose equivalence;
b. a first non-sweetener composition comprising a sucrose equivalence modifier which increases the sucrose equivalence of said at least one sweetener; and
c. a second composition comprising a sweet flavor modifier which modifies the perception of a sweet flavor.

2. The sweetener composition as in claim 1, wherein said perception of sweet flavor is increased.

3. The sweetener composition as in claim 2, wherein said second composition is selected from the group consisting of vanilla, vanillin, vanillic acid, vanillin acetate, vanillin PG acetal caffeic acid, maltol, ethyl maltol, thaumatin, furaneol, cyclotene, menthyl acetate, glycyrrhizin, perillartine, nucleotides, AMP, IMP, GMP, tagatose, erythritol, L-aspartic acid, piperine, gingerin, 1(p-methoxy phenyl)1-penten-3-one, heliotropine, o-methoxy cinnamicaldehyde, b-ionol, 4-p-acetoxylphenyl-2-butanone, 2 acetyl pyrrole, Fir Balsam Absolute, Vanillin alcohol, Piperonyl isobutyrate, Vanillylidin acetone, vanillin isobutyrate, delta and gamma lactones (C4-C14), 2,4 dimethyl benzaldehyde, menthalactone, 2-propionyl pyrrole, 4-oxoisophorone, theaspirane 3-ethyl-2-hydroxy-2-cyclopenten-1-one, furfural, veratraldehyde, zingerone, vanitrope, anisic aldehyde, anisyl alcohol, sulfurol, oak moss, benzoin, benzaldehyde, umbretalide, ethyl vanillin, phenyl acetate, cinnamyl acetate benzyl cinnamate, anethol, isophoeone phenyl ethyl buryate, phenyl ethyl proprionate, phenyl ethyl cinnamate 2,5 xylenol isomers, molasses distillates, honey distillates, sugar distillates, bitter suppressing agents, essential oils, citrus oils, expressed oils, distilled oils, rose oil, limonene, menthol, methyl butanoate, pentyl butanoate, extracts, pyridinium betaines, flavones, 2-phenylchrom-2-en-4-one. 5-hydroxyflavone, cumarine, delta lactones, methyl sorbate, divanillin, frit esters, phenyl acetaldehyde, and combinations thereof.

4. The sweetener composition as in claim 2, wherein said sweetener composition is further characterized by an aftertaste and further comprises a third composition comprising an aftertaste modifier which modifies said aftertaste.

5. The sweetener composition as in claim 4, wherein said aftertaste is decreased.

6. The sweetener composition as in claim 2, wherein said sweetener composition is further characterized by a sweetness temporal profile including a sweetness onset period and further comprises a third composition comprising a sweetness onset period modifier which modifies said sweetness onset period.

7. The sweetener composition as in claim 6, wherein said third composition extends said sweetness onset period.

8. The sweetener composition as in claim 7 wherein said sweetener composition is further characterized by a sweetness temporal profile including a sweetness peak period and further comprises a fourth composition comprising a sweetness peak period modifier which modifies said sweetness peak period.

9. The sweetener composition as in claim 8, wherein said fourth composition extends said sweetness peak period.

10. The sweetener composition as in claim 9, wherein said sweetener composition is further characterized by a sweetness temporal profile including a sweetness decay period and further comprises a fifth composition comprising a sweetness decay period modifier which modifies said sweetness decay period.

11. The sweetener composition as in claim 10, wherein said fifth composition extends said sweetness decay period.

12. A comestible comprising the sweetener composition of claim 1.

13. A sweetener composition comprising:
a. at least one sweetener having a sucrose equivalence and a temporal sweetness profile including a sweetness onset period;
b. a first non-sweetener composition comprising a sucrose equivalence modifier which increases the sucrose equivalence of said at least one sweetener; and
c. a second composition comprising a sweetness onset period modifier which modifies the sweetness onset period of said at least one sweetener.

14. The sweetener composition as in claim 13, wherein said second composition extends said sweetness onset period of said at least one sweetener.

15. A comestible comprising the sweetener composition of claim 13.

16. A sweetener composition comprising:
a. at least one sweetener having a sucrose equivalence and a temporal sweetness profile including a sweetness peak period;
b. a first non-sweetener composition comprising a sucrose equivalence modifier which increases the sucrose equivalence of said at least one sweetener; and
c. a second composition comprising a sweetness peak period modifier which modifies said sweetness peak period of said at least one sweetener.

17. The sweetener composition as in claim 16, wherein said second composition extends said sweetness peak period of said at least one sweetener.

18. A comestible comprising the sweetener composition of claim 16.

19. A sweetener composition comprising:
a. at least one sweetener having a sucrose equivalence and a temporal sweetness profile including a sweetness decay period;
b. a first non-sweetener composition comprising a sucrose equivalence modifier which increases the sucrose equivalence of said at least one sweetener; and
c. a second composition comprising a sweetness decay period modifier which modifies said sweetness decay period of said at least one sweetener.

20. The sweetener composition as in claim 19, wherein said second composition extends said sweetness decay period of said at least one sweetener.

21. The sweetener composition as in claim 20, wherein said second composition is selected from the group consisting of L-lysine, magnesium gluconate, and combinations thereof.

22. A comestible comprising the sweetener composition of claim 19.

23. A sweetener composition comprising:
a. at least one sweetener having a sucrose equivalence and a temporal sweetness profile including an aftertaste;
b. a first non-sweetener composition comprising a sucrose equivalence modifier which increases the sucrose equivalence of said at least one sweetener; and
c. a second composition comprising an aftertaste modifier which modifies said aftertaste of said at least one sweetener.

24. The sweetener composition as in claim 23, wherein said second composition is decreases said aftertaste of said at least one sweetener.

25. The sweetener composition as in claim 24, wherein said second composition is selected from the group consisting of yerba santa, monocarboxylic acids, dicarboxylic acids, calcium lactate, magnesium lactate, sodium lactate, calcium gluconate, sodium gluconate, monosodium gluconate, magnesium gluconate, β-alanine, trans-4-hydroxy-1-proline, trans-4-hydroxy-D-proline, L-arginine, L-tryptophan, balsam peru, quinine, naringin, naringenin, sugar alcohols, polyols, erythritol, maltitol, sorbitol, isomalt, tagatose, trehalose, fructo oligo saccharides, alkali metal cations, alkaline earth metal cations, benzyl amides, hydroxylated benzoic acid amides, homoeriodictyol, sodium salt of homoeriodictyol, serubin, eriodictyol, eriodictyol-7-methylether, cream of tartar, galactose, phospholipids, monellin, tannic acid, phenolic acid, and combinations thereof.

26. A comestible comprising the sweetener composition of claim 23.

27. A beverage composition comprising:
a. a first amount of 3-hydroxybenzoic acid;
b. a second amount of 3,4-dihydroxybenzoic acid;
c. a third amount of a taste modifying compound selected from the group consisting of maltol, thaumatin, and combinations thereof; and
d. a fourth amount of at least one sweetener selected from the group consisting of sucrose, high fructose corn syrup, corn syrup, sucromalt, isomaltulose, lactose, galactose, xylose, oligosaccharides, fructooligosaccharides, polydextrose, honey, brown rice syrup, agave syrup, molasses, brown sugar, and combinations thereon.

28. A method of making a sweetener composition comprising the steps of:
a. providing at least one sweetener having a sucrose equivalence; and
b. providing a first composition comprising a sucrose equivalence modifier capable of increasing the sucrose equivalence of said at least one sweetener, wherein said increased sucrose equivalence is greater than the sucrose equivalence of said at least one sweetener.

29. A method of reducing an amount of at least one sweetener in a comestible providing the steps of:
a. determining a first amount of a first composition comprising at least one sweetener having a sucrose equivalence;
b. reducing said first amount by at least 30% w/w; and
c. determining a second amount of a second composition comprising a sucrose equivalence modifier which increases the sucrose equivalence of said at least one sweetener wherein said second amount is capable of providing said sucrose equivalence.
